(19) United States
(12) Patent Application Publication
(10) Pub. No.: US 2025/0356686 A1
(43) Pub. Date: Nov. 20, 2025

(54) METHOD OF CONTROLLING FINGERPRINT SENSOR AND ELECTRONIC DEVICE SUPPORTING SAME

(71) Applicant: SAMSUNG ELECTRONICS CO., LTD., Suwon-si (KR)

(72) Inventors: Dongchurl KIM, Suwon-si (KR); Suna Kim, Suwon-si (KR); Youngjae Kim, Suwon-si (KR); Jeonghoo Kim, Suwon-si (KR); Taeyoon AN, Suwon-si (KR); Yunejae Hwang, Suwon-si (KR)

(73) Assignee: SAMSUNG ELECTRONICS CO., LTD., Suwon-si (KR)

(21) Appl. No.: 19/089,795

(22) Filed: Mar. 25, 2025

Related U.S. Application Data
(63) Continuation of application No. PCT/KR2025/099531, filed on Mar. 4, 2025.

(30) Foreign Application Priority Data
May 20, 2024 (KR) 10-2024-0065250
Aug. 20, 2024 (KR) 10-2024-0111381

(51) Int. Cl. G06V 40/13; G06F 21/32; G06V 10/141; G06V 10/30

(52) U.S. Cl. CPC G06V 40/1318; G06F 21/32; G06V 10/141; G06V 10/30

(57) ABSTRACT

An electronic device, including: a display; a fingerprint sensor under the display; one or more memories configured to store instructions; and one or more processors operable to execute the instructions to cause the electronic device to: detect an occurrence of an event for sensing a fingerprint of a user, based on detecting the occurrence, obtain a first image using the fingerprint sensor before the display emits light at a predetermined intensity for sensing the fingerprint, analyze at least one pattern corresponding to a flicker noise included in the first image to obtain an analysis result, based on the analysis result, adjust at least one exposure time of the fingerprint sensor for sensing the light reflected by the fingerprint of the user, and based on the adjusted at least one exposure time, obtain a second image using the fingerprint sensor by sensing the light reflected by the fingerprint of the user.

### CROSS-REFERENCE TO RELATED APPLICATION(S)

This application is a continuation application of International Application No. PCT/KR2025/099531, filed on Mar. 4, 2025, which is based on and claims priority to Korean Application Number 10-2024-0065250, filed on May 20, 2024, in the Korean Intellectual Property Office, and of a Korean patent application number 10-2024-0111381, filed on Aug. 20, 2024, in the Korean Intellectual Property Office, the disclosure of each of which is incorporated by reference herein in its entirety.

### BACKGROUND

### 1. Field

The disclosure relates to a method of controlling a fingerprint sensor and an electronic device supporting same.

### 2. Description of Related Art

Various biometric authentication technologies may be applied to electronic devices. One commonly used biometric authentication technology is fingerprint authentication technology. For example, an electronic device including a display (e.g., a touch screen) capable of detecting a touch by a finger, etc., to obtain a fingerprint (e.g., a fingerprint image or fingerprint information) by using a fingerprint sensor disposed at a position corresponding to at least a partial area of the display.

When a fingerprint image is obtained using the fingerprint sensor, the electronic device may cause the display to emit light having an intensity equal to or greater than a designated or predetermined intensity in order to obtain a fingerprint image having a quality that is equal to or greater than a designated or predetermined quality. For example, the electronic device may control the fingerprint sensor to obtain a fingerprint image while pixels of the display corresponding to a position or area of the fingerprint sensor are emitting light having an intensity equal to or greater than a designated or predetermined intensity.

The fingerprint sensor may include a fingerprint sensor using a rolling shutter method of sequentially obtaining (e.g., capturing) and performing a readout of light in a unit of rows of pixels of the fingerprint sensor, thereby obtaining an image (e.g., a fingerprint image), and a fingerprint sensor using a global shutter method of simultaneously obtaining and performing a readout of light by pixels of the fingerprint sensor, thereby obtaining an image. The fingerprint sensor using the global shutter method may obtain a fingerprint image with higher performance compared to the fingerprint sensor using the rolling shutter method, but may have a complex circuit configuration and thus may have a larger size and consume many resources during operation.

A quality of an image (e.g., a quality of a fingerprint image) obtained by a fingerprint sensor (e.g., a fingerprint sensor using the rolling shutter method) may be affected by not only the intensity of light emitted by a display, but also a period during which the display emits light. For example, the display may display a screen through an operation of periodically turning on and turning off (e.g., activating and deactivating) according to a refresh rate of the display. According to embodiments, a period in which or during which a display is turned on and then turned off (e.g., is activated and then deactivated) may be referred to as a period during which the display is turned on/off, or an on/off period. When at least some of rows of pixels of a fingerprint sensor operated by the rolling shutter method obtain light emitted from the display for different times (e.g., times for which the pixels of the fingerprint sensor are exposed to light), a pattern caused by flicker noise may occur in an image obtained using the fingerprint sensor.

An electronic device may, in order to minimize the flicker noise, set, for a period during which the display is turned on/off, a ratio, which may be referred to as an off ratio (OR) of an amount of time for which the display is turned off in the period, to an amount of time corresponding to the period (e.g., a time for one period during which the display is turned on/off) to be a designated or predetermined ratio or smaller. However, in this case, external light may be detected during the time in which the display is turned off, and thus it may be difficult for an illuminance sensor to accurately measure the illuminance of the electronic device. Accordingly, the OR may be maintained at about 10% or higher to reduce or minimize the flicker noise occurring in a fingerprint image (or prevent the flicker noise from occurring). Accordingly, the electronic device may transmit information about an on/off period of the display to the fingerprint sensor through electrical wiring during every period in which the display is turned on/off, thereby maintaining the OR at about 10% or higher and minimizing the flicker noise. However, this may cause a problem in that the electronic device may require a separate circuit or circuit block.

The electronic device may control the fingerprint sensor such that each pixel of the fingerprint sensor may detect light during an exposure time (a time for which each pixel of the fingerprint sensor is exposed to light) obtained by performing multiplication by an integer (which may also be referred to as “integer multiplication”) for a period during which the display is turned on/off, thereby maintaining the OR at about 10% or higher and minimizing the flicker noise without a separate circuit element.

A period during which the display is actually turned on/off may be set by using a clock generated by an oscillator of the electronic device (by multiplying, by an integer, the clock generated by the oscillator). The clock generated by the oscillator may be changed by an external environment of the electronic device (e.g., the temperature of the electronic device, the ambient brightness of the electronic device, and the brightness of the display of the electronic device). In addition, the clock generated by the oscillator may differ according to each oscillator mounted in the electronic device. For example, there may be variations among oscillators manufactured by the same process, and the clock predicted to be generated by the oscillator mounted in the electronic device may differ from the clock actually generated by the oscillator. If a time for which each row of pixels of the fingerprint sensor (e.g., the fingerprint sensor using the rolling shutter method) is exposed to light is set or selected to be an integer multiple of a period during which the display is turned on/off, and then the clock generated by the oscillator is changed, the time for which each row of the pixels of the fingerprint sensor is exposed to light may not be an integer multiple of a period during which the display is actually turned on/off. In this case, a pattern caused by flicker noise may be present in an image obtained using the fingerprint sensor. In the above examples, flicker noise is described as being generated by changing of the clock generated by the oscillator, but embodiments are not limited thereto. For example, when a clock (e.g., a clock for counting an exposure time) of the fingerprint sensor for obtaining light by the fingerprint sensor is changed, flicker noise may occur.

The above-described information may be provided as related art for the purpose of assisting in understanding the disclosure. No assertion or decision is made as to whether any of the above might be applicable as prior art with regard to the disclosure.

### SUMMARY

An embodiment of the disclosure relates to a method of controlling a fingerprint sensor and an electronic device supporting same, enabling adjustment of an exposure time of the fingerprint sensor (e.g., a time for which each row of pixels of the fingerprint sensor obtains light), based on an image obtained using the fingerprint sensor, and allowing the fingerprint sensor to obtain light for the adjusted exposure time.

The technical subjects pursued in the disclosure may not be limited to the above mentioned technical subjects, and other technical subjects which are not mentioned may be clearly understood from the following descriptions by those skilled in the art to which the disclosure pertains.

In accordance with an aspect of the disclosure, an electronic device includes: a display; a fingerprint sensor under the display; one or more memories configured to store processor-executable instructions; and one or more processors including electronic circuitry, wherein the one or more processors may be individually or collectively operable to execute the instructions stored on the one or more memories to cause the electronic device to: detect an occurrence of an event for sensing a fingerprint of a user, based on detecting the occurrence, obtain a first image using the fingerprint sensor before the display emits light at a predetermined intensity for sensing the fingerprint, analyze at least one pattern corresponding to a flicker noise included in the first image to obtain an analysis result, based on the analysis result, adjust at least one exposure time of the fingerprint sensor for sensing the light reflected by the fingerprint of the user, and based on the adjusted at least one exposure time, obtain a second image using the fingerprint sensor by sensing the light reflected by the fingerprint of the user.

The one or more processors may be individually or collectively operable to execute the instructions to further cause the electronic device to: based on detecting the occurrence of the event, and before the display emits the light: provide, to the display, a first signal for emitting the light, and provide, to the fingerprint sensor, a second signal for obtaining the first image, and obtain the first image based on a plurality of pixel values that are obtained sequentially in units of rows of pixels included in the fingerprint sensor.

The first signal may include: a command for activating the fingerprint sensor, a command for obtaining, by the fingerprint sensor, first pixel values corresponding to the first image, a command for obtaining, by the fingerprint sensor, second pixel values corresponding to the second image after emitting the light, and the at least one exposure time stored in the one or more memories.

The at least one pattern may include a plurality of first portions and a plurality of second portions that are darker than the plurality of first portions, wherein the plurality of first portions and the plurality of second portions appear alternatingly and repeatedly in the first image, and

The one or more processors may be individually or collectively operable to execute the instructions to further cause the electronic device to: obtain an average pixel value corresponding to each row from among the rows, determine an interval at which the plurality of first portions and the plurality of second portions appear in the first image, determine a number of the rows corresponding to the interval, and the at least one exposure time may be adjusted based on the determined number to obtain the adjusted at least one exposure time.

The occurrence of the event may be detected while displaying a screen for registering the fingerprint using the display, and the one or more processors may be individually or collectively operable to execute the instructions to further cause the electronic device to: based on the adjusted at least one exposure time, obtain one or more fingerprint images using the fingerprint sensor by sensing the light, reflected by the fingerprint of the user.

The first image may be obtained based on displaying a fingerprint icon using the display.

The one or more processors may be individually or collectively operable to execute the instructions to further cause the electronic device to: determine a number of a plurality of activated pixels, which are in on state, from among a plurality of first pixels in a region corresponding to a location of the fingerprint sensor; and obtain the first image based on determining that a ratio of the number of the plurality of activated pixels to the number of the plurality of first pixels is equal to or greater than a predetermined ratio.

In accordance with an aspect of the disclosure, a method of controlling a fingerprint sensor in an electronic device includes detecting an occurrence of an event for sensing a fingerprint of a user; based on the detecting of the occurrence of the event, obtaining a first image using the fingerprint sensor before a display of the electronic device emits light at a predetermined intensity for sensing the fingerprint; analyzing at least one pattern corresponding to a flicker noise included in the first image to obtain an analysis result; based on the analysis result, adjusting at least one exposure time of the fingerprint sensor for sensing the light reflected by the fingerprint of the user; and based on the adjusted at least one exposure time, obtaining a second image using the fingerprint sensor by sensing the light reflected by the fingerprint of the user.

The obtaining of the first image using the fingerprint sensor may include: based on detecting the occurrence of the event, and before the display emits the light: providing, to the display, a first signal for emitting the light, and providing, to the fingerprint sensor, a second signal for obtaining the first image; and obtaining the first image based on a plurality of pixel values that are obtained sequentially in units of rows of pixels included in the fingerprint sensor.

The first signal may include: a command for activating the fingerprint sensor, a command for obtaining, by the fingerprint sensor, first pixel values of corresponding to the first image, a command for obtaining, by the fingerprint sensor, second pixel values corresponding to the second image after emitting the light, and the at least one exposure time stored in memory of the electronic device.

The at least one pattern may include a plurality of first portions and a plurality of second portions that are darker than the plurality of first portions, wherein the plurality of first portions and the plurality of second portions appears alternatingly and repeatedly in the first image, the analyzing of the at least one pattern may include: obtaining an average pixel value corresponding to each row from among the rows; determining an interval at which the plurality of first portions and the plurality of second portions appear in the first image; and determining a number of rows corresponding to the interval, and the at least one exposure time is adjusted based on the determined number to obtain the adjusted at least one exposure time.

The occurrence of the event may be detected while displaying a screen for registering the fingerprint using the display, and the method may further include: based on the adjusted at least one exposure time, obtaining one or more fingerprint images using the fingerprint sensor by sensing the light reflected by the fingerprint of the user.

The first image may be obtained based on displaying a fingerprint icon using the display.

In accordance with an aspect of the disclosure, an electronic device includes: a display; a fingerprint sensor under the display and configured to obtain an image by sensing light; one or more memories storing processor-executable instructions; and one or more processors including electronic circuitry, wherein the one or more processors may be individually or collectively operable to execute the instructions to cause the electronic device to: display a first screen using the display; during at least some of a time in which the first screen is displayed, obtain a first image using the fingerprint sensor according to a first exposure time; based on the first image, determine a second exposure time for the fingerprint sensor; detect a contact by a finger of a user; based on the contact being detected, display a second screen using the display; during at least some of a time in which the second screen is displayed, obtain a second image corresponding to the finger through the fingerprint sensor according to the second exposure time; based on the second image, obtain fingerprint information corresponding to the finger; and based on the fingerprint information, perform at least one of fingerprint authentication and fingerprint registration corresponding to the user.

The first exposure time may be set based on refresh rate information associated with the display, and the one or more processors may be individually or collectively operable to execute the instructions to further cause the electronic device to: determine adjusted refresh rate information associated with the display based on the first image; and determine the second exposure time based on the adjusted refresh rate information.

The electronic may further include a sensor configured to detect external environment information corresponding to the electronic device, and the one or more processors may be individually or collectively operable to execute the instructions to cause the electronic device to: detect the external environment information using the sensor; and based on determining that the external environment information satisfies a predetermined condition, perform an operation for obtaining the first image.

The one or more processors may be individually or collectively operable to execute the instructions to further cause the electronic device to: based on the determining that the external environment information satisfies the predetermined condition, display, using the display, an indicator indicating that the operation for obtaining the first image is to be performed.

The one or more processors may be individually or collectively operable to execute the instructions to further cause the electronic device to: based on the determining that the external environment information satisfies the predetermined condition, display, using the display, a user interface for receiving a user input for executing the operation for obtaining the first image.

The second screen may include a fingerprint sensing area on the fingerprint sensor, and the one or more processors may be individually or collectively operable to execute the instructions to further cause the electronic device to display the second screen such that a brightness of the fingerprint sensing area is higher than a brightness of a corresponding area of the first screen.

The one or more processors may be individually or collectively operable to execute the instructions to further cause the electronic device to display a first guide image in the corresponding area and a second guide image in the fingerprint sensing area, and the first guide image may differ from the second guide image by at least one attribute.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram of an electronic device in a network environment according to an embodiment;

FIG. 2 is a block diagram of an electronic device according to an embodiment;

FIG. 3 is a diagram illustrating elements included in a fingerprint sensor according to an embodiment;

FIG. 4 is a diagram illustrating an operation of a fingerprint sensor according to an embodiment;

FIG. 5 is a diagram illustrating the placement of a fingerprint sensor in an electronic device according to an embodiment;

FIG. 6 is a diagram illustrating a method of controlling a fingerprint sensor in a comparative example according to an embodiment;

FIG. 7 is a flowchart illustrating a method of controlling a fingerprint sensor according to an embodiment;

FIG. 8 is a diagram illustrating a method of detecting an event for sensing a user's fingerprint according to an embodiment;

FIG. 9 is a diagram illustrating a pattern caused by flicker noise in a first image according to an embodiment;

FIG. 10 is a flowchart illustrating a method of adjusting an exposure time according to an embodiment;

FIG. 11A is a diagram illustrating a method of adjusting an exposure time according to an embodiment;

FIG. 11B is a diagram illustrating a method of adjusting an exposure time according to an embodiment;

FIG. 12 is a diagram illustrating a method of controlling a fingerprint sensor according to an embodiment;

FIG. 13 is a flowchart illustrating a method of controlling a fingerprint sensor according to an embodiment;

FIG. 14 is a flowchart illustrating a method of controlling a fingerprint sensor according to an embodiment;

FIG. 15 is a diagram illustrating a method of controlling a fingerprint sensor according to an embodiment;

FIG. 16 is a flowchart illustrating a method of controlling a fingerprint sensor according to an embodiment;

FIG. 17 is a diagram illustrating a method of controlling a fingerprint sensor according to an embodiment;

FIG. 18 is a flowchart illustrating a method of controlling a fingerprint sensor according to an embodiment;

FIG. 19 is a diagram illustrating images including a pattern caused by flicker noise according to an embodiment;

FIG. 20 is a flowchart illustrating a method of controlling a fingerprint sensor according to an embodiment;

FIG. 21 is a diagram illustrating a method of controlling a fingerprint sensor according to an embodiment; and

FIG. 22 is a diagram illustrating a method of controlling a fingerprint sensor according to an embodiment.

### DETAILED DESCRIPTION

Hereinafter, embodiments of the disclosure are described in detail with reference to the drawings so that those skilled in the art to which the disclosure pertains may more easily implement the disclosure. However, the disclosure may be implemented in various forms and is not limited to embodiments set forth herein. With regard to the description of the drawings, the same or similar reference signs may be used to designate the same or similar elements. Also, in the drawings and the relevant descriptions, description of well-known functions and configurations may be omitted for the sake of clarity and brevity.

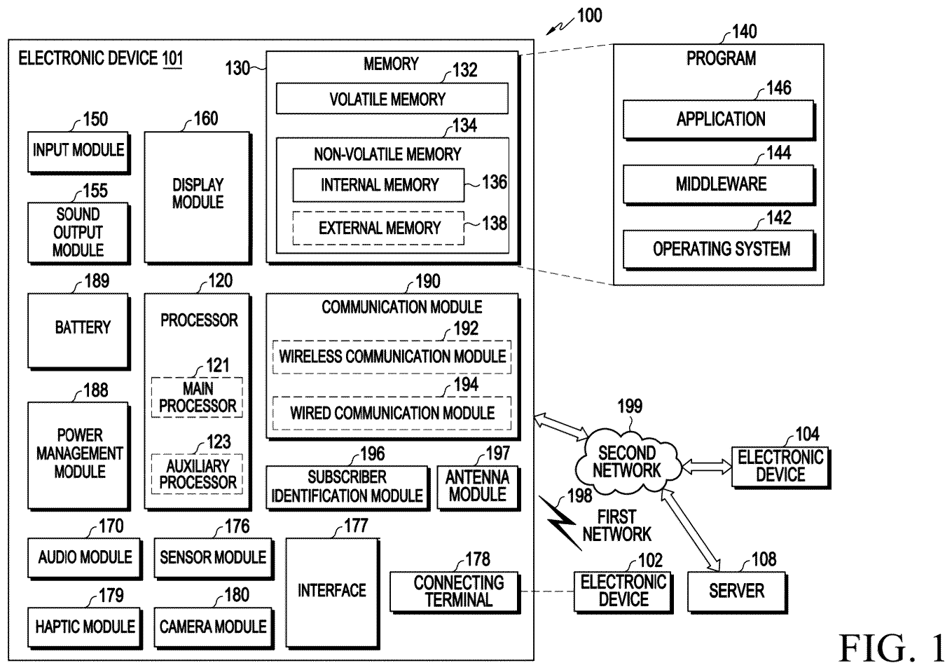

FIG. 1 is a block diagram illustrating an electronic device 101 in a network environment 100 according to various embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

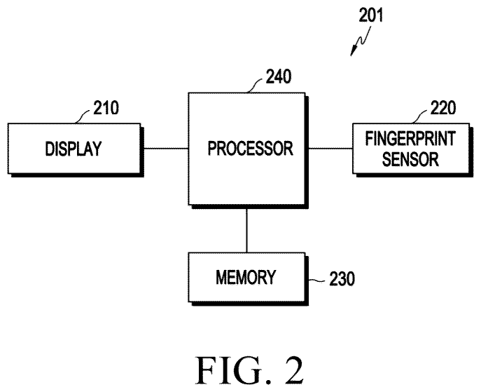

FIG. 2 is a block diagram of an electronic device 201 according to an embodiment.

Referring to FIG. 2, in an embodiment, the electronic device 201 may be or may correspond to the electronic device 101 of FIG. 1.

In an embodiment, the electronic device 201 may include a display 210, a fingerprint sensor 220, memory 230, and/or a processor 240.

In an embodiment, the display 210 may be included in the display module 160 shown in FIG. 1.

In an embodiment, the display 210 may include a display panel, a display driver integrated circuit (DDI) (which may also be referred to as a display driver) for controlling the display panel, and a touch circuit. However, embodiments are not limited thereto, and the DDI and/or the touch circuit may be included in the electronic device 201 independently of the display 210.

In an embodiment, the display 210 (e.g., the display panel and the DDI) may include a display operated based on a clock generated by an oscillator of the electronic device 201. For example, the display 210 may include a display that performs a refresh operation (e.g., an operation of turning on/off by the display), based on a period obtained by performing multiplication by an integer (which may also be referred to as “integer multiplication”) for a period of a clock generated by the oscillator, such as an active matrix organic light emitting diode (AMOLED) display.

In an embodiment, the DDI may store, in the memory 230, at least a portion of image data received from a main processor (e.g., the main processor 121 in FIG. 1) (e.g., application processor) or an auxiliary processor (e.g., the auxiliary processor 123 in FIG. 1) (e.g., a graphics processing device) which may be operated independently of a function of the main processor. The DDI may display the at least a portion of the image data using the display panel.

In an embodiment, the touch circuit may include a touch sensor and a touch sensor integrated circuit (IC) for controlling the touch sensor. The touch sensor IC may control the touch sensor to detect a touch input or a hovering input on a particular position on the display. For example, the touch sensor IC may detect a touch input or hovering input by measuring a change in a signal (e.g., voltage, quantity of light, resistance, or quantity of electric charge) on a particular position on the display. The touch sensor IC may provide information (e.g., position, area, pressure, or time) relating to a detected touch input or hovering input to the processor 240.

In an embodiment, the display 210 may display various information. For example, the display 210 may display an image related to a fingerprint (e.g., a fingerprint image representing a position on which a user's fingerprint may be input, which may also be referred to as “fingerprint icon”, on a position of the display 210 corresponding to a position at which the fingerprint sensor 220 is disposed. For example, the display 210 may display information for guiding a user to register a fingerprint while an operation for fingerprint registration is being performed. However, the information displayed by the display 210 is not limited to the above example.

In an embodiment, the display 210 may emit light set for acquisition of fingerprint information. For example, during fingerprint authentication or fingerprint registration, from among all pixels of the display 210, pixels arranged (or positioned) at a position (or in an area) corresponding to a position (or area) of the fingerprint sensor 220 in the display 210 may emit light having an intensity equal to or greater than a designated or predetermined intensity (e.g., light emitted at a predetermined intensity for sensing a user's fingerprint).

In an embodiment, the fingerprint sensor 220 (which may also be referred to as “fingerprint recognition sensor”) may obtain information for obtaining an image (e.g., fingerprint image), based on a touch input on the display 210.

In an embodiment, the fingerprint sensor 220 may obtain a user's fingerprint image using an optical method based on the difference between light rays reflected by ridges and valleys included in a fingerprint. However, the method of obtaining a fingerprint image by the fingerprint sensor 220 is not limited to the above examples.

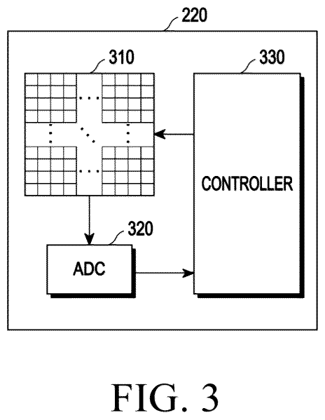

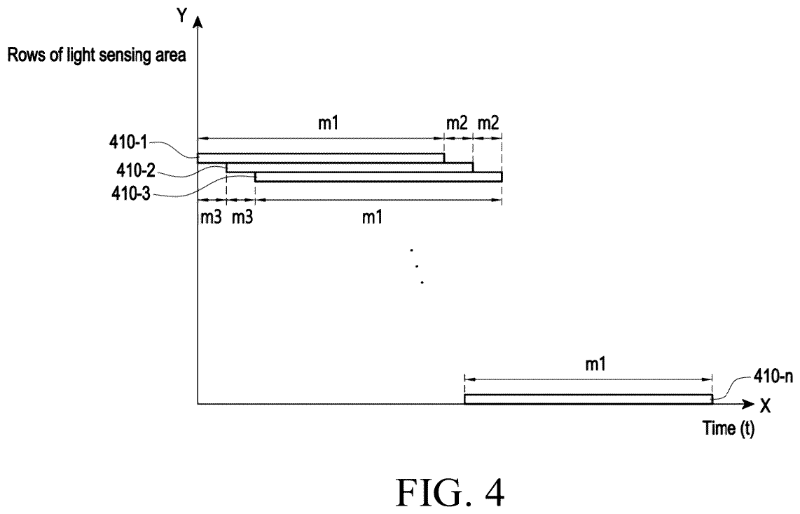

In an embodiment, the fingerprint sensor 220 may obtain light (e.g., light emitted from the display 210 and/or external light) to obtain (e.g., generate) an image. Hereinafter, with reference FIG. 3 and FIG. 4, examples of the fingerprint sensor 220 and an operation of the fingerprint sensor 220 are described in more detail.

FIG. 3 is a diagram illustrating elements included in the fingerprint sensor 220 according to an embodiment.

FIG. 4 is a diagram illustrating an operation of the fingerprint sensor 220 according to an embodiment.

Referring to FIG. 3 and FIG. 4, in an embodiment, the fingerprint sensor 220 may include a complementary metal oxide semiconductor (CMOS)-based image sensor. However, embodiments are not limited thereto, and the fingerprint sensor 220 may include a charge-coupled device (CCD)-based image sensor.

In an embodiment, the fingerprint sensor 220 may include a light sensing area 310 (which may also be referred to as “light responsive area” or “light detection area”), an analog-to-digital converter (ADC) 320, and a controller 330 (which may also be referred to as “control circuit”).

In an embodiment, the light sensing area 310 may include multiple pixels (e.g., a pixel array). The respective multiple pixels included in the light sensing area 310 may include photodiodes configured to perform an operation (referred to as “scan”) of converting obtained light into an electrical signal (e.g., charge) through a photoelectric conversion operation. The light sensing area 310 may include a circuit (e.g., transistors) capable of converting an electrical signal converted in the photodiodes into an analog signal (e.g., electrical analog signal). In an embodiment, the light sensing area 310 may include an active area.

In an embodiment, the ADC 320 may convert the analog signal received from the light sensing area 310 into a digital signal (e.g., electrical digital signal). The ADC 320 may provide (e.g., transfer) the digital signal to the controller 330.

In an embodiment, the digital signal output from the ADC 320 may include values obtained in pixels of the fingerprint sensor 220 (e.g., values obtained at respective positions by pixels of the fingerprint sensor 220). Hereinafter, a digital signal output from the ADC 320 may be referred to as “pixel values of the fingerprint sensor 220” or “pixel values of pixels of the fingerprint sensor 220”.

In an embodiment, the controller 330 may control the light sensing area 310 (and the ADC 320).

In an embodiment, the controller 330 may store, in the memory 230 (e.g., the memory included in the fingerprint sensor 220), the digital signal received from the ADC 320. The controller 330 may transfer the digital signal to the processor 240.

In an embodiment, the controller 330 may be implemented as an application specific IC (ASIC) or system on chip (SoC).

In an embodiment, the fingerprint sensor 220 may obtain pixel values of the fingerprint sensor 220 by using a rolling shutter method. For example, the fingerprint sensor 220 using the rolling shutter method may obtain pixel values sequentially for each row of pixels included in the fingerprint sensor 220. Hereinafter, with reference to FIG. 4, an example of an operation of obtaining pixel values by the fingerprint sensor 220 using the rolling shutter method is described.

In an embodiment, in FIG. 4, the X-axis may represent time (t), and the Y-axis may represent rows of pixels of the fingerprint sensor 220.

In an embodiment, in FIG. 4, block 410-1, block 410-2, block 410-3, and block 410-n (where n denotes a total number of rows of pixels included in the light sensing are 310) may represent operations of converting light into an electrical signal by respective rows of pixels included in the light sensing area 310. For example, block 410-1 may represent an operation of converting light into an electrical signal by a first row of pixels which are arranged at a first position (e.g., at the uppermost part of the light sensing area 310) among the pixels included in the light sensing area 310, block 410-2 may represent an operation of converting light into an electrical signal by a row (e.g., a row immediate after to the first row) (which may also be referred to as “second row”) of pixels secondly arranged among the pixels included in the light sensing area 310, and block 410-n may represent an operation of converting light into an electrical signal by a row (which may also be referred to as “n-th row”) of pixels which are arranged last (e.g., at the lowermost part of the light sensing area 310) among the pixels included in the light sensing area 310.

In an embodiment, each pixel included in the light sensing area 310, when light is obtained, converts the obtained light into an electrical signal, and thus an operation of converting light into an electrical signal by each pixel included in the light sensing area 310 may be called an operation of obtaining light by each pixel included in the light sensing area 310.

In an embodiment, in the fingerprint sensor 220 (e.g., a fingerprint sensor using the rolling shutter method), each row of the pixels of the light sensing area 310 may obtain light for a same amount of time. For example, as illustrated in FIG. 4, in the fingerprint sensor 220 using the rolling shutter method, each row of the pixels of the light sensing area 310 may be exposed to light during a time m1. The pixels included in the same row may obtain light simultaneously (e.g., at the same time and for the same amount of time). A time (e.g., the time m1) for which each row of the pixels of the light sensing area 310 obtains light may be referred to as “an exposure time”.

In an embodiment, the fingerprint sensor 220 (e.g., a fingerprint sensor using the rolling shutter method) may perform a readout operation sequentially for each row of the pixels of the light sensing area 310 (e.g., in a unit of rows for the rows of the pixels of the light sensing area 310). For example, the fingerprint sensor 220 may, based on light obtained for an exposure time m1 by a first row of the pixels of the light sensing area 310, perform a first readout operation for the first row for a time m2. The fingerprint sensor 220 may perform the first readout operation for the first row for the time m2 and then sequentially, based on light obtained for the exposure time m1 by a second row of the pixels of the light sensing area 310, perform a second readout operation for the second row for the time m2.

In an embodiment, a readout operation for each row of the pixels of the light sensing area 310 may include an operation of converting an electrical signal (e.g., an electrical signal output by obtaining light by each row of the pixels of the light sensing area 310) into an analog signal by each row of the pixels of the light sensing area 310, an operation of converting the analog signal into a digital signal, and an operation of storing the digital signal in memory (e.g., the memory in the fingerprint sensor 220). In some embodiments, the readout operation may further include an operation of transferring the digital signal stored in the memory to the processor 240 and then removing pixel values stored in the memory. For example, the first readout operation for the first row of the light sensing area 310 may include an operation of converting an electrical signal output by obtaining light by the first row of the light sensing area 310 into an analog signal, an operation of converting the analog signal into a digital signal, an operation of storing the digital signal in the memory of the fingerprint sensor 220, an operation of transferring the digital signal to the processor 240, and an operation of removing the digital signal stored in the memory of the fingerprint sensor 220.

In an embodiment, a time for which a readout operation is performed (which may be referred to as a “readout time” or “transfer time”) may be substantially the same for each row of the pixels of the light sensing area 310. For example, as illustrated in FIG. 4, a readout time of the first row of the pixels of the light sensing area 310 and a readout time of the second row of the pixels of the light sensing area 310 may both be the time m2. In an embodiment, readout operations for the rows of the pixels of the light sensing area 310 may be continuously performed (e.g., seamlessly). For example, a readout operation for the first row of the pixels of the light sensing area 310 may be performed, and then immediately, a readout operation of the second row of the pixels of the light sensing area 310 may be performed.

In an embodiment, for the rows of the pixels of the light sensing area 310, the difference between a time point at which a row starts to obtain light and a time point at which a next row (e.g., a row immediately after the previous row) starts to obtain light may be the same. For example, as illustrated in FIG. 4, the difference between a time point at which the first row starts to obtain light and a time point at which the second row starts to obtain light, and the difference between a time point at which the second row starts to obtain light and a time point at which the third row starts to obtain light, may both be a time m3.

In an embodiment, for the rows of the pixels of the light sensing area 310, the difference between a time point at which a row starts to obtain light and a time point at which a row right after the row starts to obtain light may be the same as the readout time of the row. For example, as illustrated in FIG. 4, the time m3 as the difference between a time point at which the first row starts to obtain light and a time point at which the second row starts to obtain light may be the same as the readout time m2 of the first row.

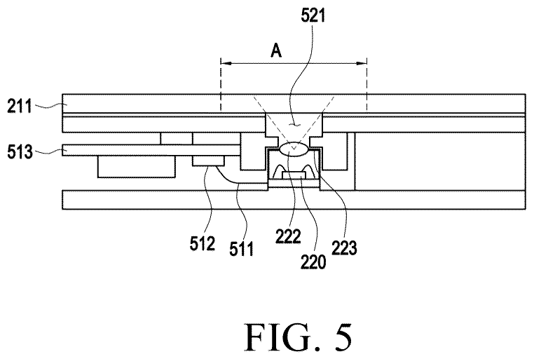

In an embodiment, the fingerprint sensor 220 may be disposed under the display 210 (or in the display 210). Hereinafter, with reference to FIG. 5, an example of a placement of the fingerprint sensor 220 in the electronic device 201 is described.

FIG. 5 is a diagram illustrating the placement of the fingerprint sensor 220 in the electronic device 201 according to an embodiment.

Referring to FIG. 5, in an embodiment, as illustrated in FIG. 5, the fingerprint sensor 220 may be disposed under the display 210 (e.g., the display panel 211). However, embodiments are not limited thereto, and the fingerprint sensor 220 may be disposed in the display 210.

In an embodiment, light emitted from the display panel 211 may be reflected (e.g., reflected by a user's fingerprint) and then received by a lens 222 through an opening 521. The fingerprint sensor 220 may obtain light that is incident on the fingerprint sensor 220 after being received by the lens 222.

In an embodiment, in FIG. 5, an area A on the display panel 211 may correspond to an area of pixels that are arranged at a position (or in an area) corresponding to a position (or area) of the fingerprint sensor 220 in the display panel 211 among all pixels of the display panel 211, and that emit light having an intensity equal to or greater than a designated or predetermined intensity, during fingerprint authentication or fingerprint registration.

In an embodiment, a lens support part 223 shown in FIG. 5 may support the lens 22.

In an embodiment, the fingerprint sensor 220 may be connected through a wire 511 to a connector 512 electrically connected to a printed circuit board 513.

In an embodiment, the memory 230 may be included in the memory 130 in FIG. 1.

In an embodiment, the memory 230 may store information for controlling the fingerprint sensor 220. Examples of information stored by the memory 230 to control the fingerprint sensor 220 are described below in greater detail.

In an embodiment, the processor 240 may be included in the processor 120 in FIG. 1.

In an embodiment, the processor 240 may control the overall operations that controls the fingerprint sensor 220. In an embodiment, the processor 240 may include one or more processors for controlling the fingerprint sensor 220. For example, the processor 240 may correspond to multiple processors that collectively perform multiple operations distributed therebetween. Examples of operations of controlling the fingerprint sensor 220 by the processor 240 are described below in greater detail.

FIG. 2 illustrates an example in which the electronic device 201 includes the display 210, the fingerprint sensor 220, the memory 230, and the processor 240, but embodiments are not limited thereto. For example, the electronic device 201 may further include at least one element (component) (e.g., an inertial sensor configured to obtain the movement of the electronic device 201, or a temperature sensor configured to obtain the temperature of the electronic device 201) illustrated in FIG. 1.

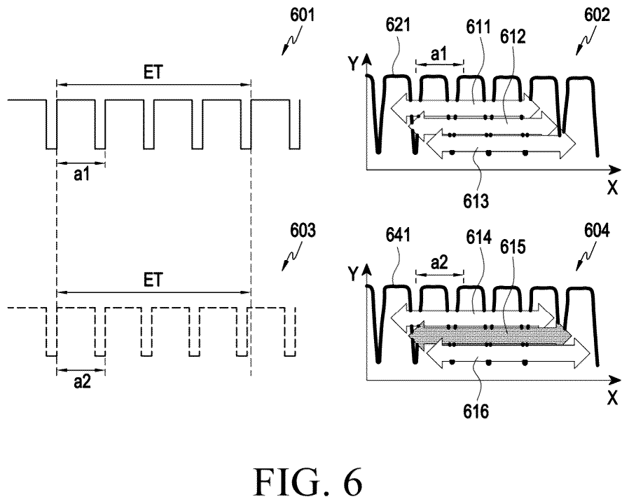

FIG. 6 is a diagram illustrating a method of controlling a fingerprint sensor in a comparative example according to an embodiment.

Referring to FIG. 6, in an embodiment, a quality of an image (e.g., a quality of a fingerprint image obtained through a fingerprint sensor) obtained through a fingerprint sensor (e.g., a fingerprint sensor using the rolling shutter method) may be affected by not only the intensity of light emitted by the display, but also a period during which the display emits light. For example, as shown in graph 601 in FIG. 6, the display may be periodically turned on/off (e.g., turned on and turned off once every time period a1), based on a refresh rate of the display. When at least two rows among rows of pixels of the fingerprint sensor obtain light emitted from the display for different exposure times by the rolling shutter method, and then readout operations are performed, flicker noise may occur in an image obtained using the fingerprint sensor 220. Graph 601 may show an example in which an initial on/off period of the display is about 4.16 ms (e.g., when the refresh rate of the display is 240 Hz) and an exposure time ET is about 16.64 ms obtained by multiplying the initial on/off period of the display by an integer four (“4”).

In an embodiment, in a comparative example, the electronic device 201 may control the fingerprint sensor such that each pixel of the fingerprint sensor obtains light for the exposure time ET obtained by multiplying, by an integer, a period (e.g., a time a1) during which the display is turned on/off, thereby minimizing flicker noise occurring in an image obtained using the fingerprint sensor. For example, according to graph 602 in FIG. 6, the X-axis may represent time, and the Y-axis may denote the intensity of light (e.g., the intensity of light obtained by the fingerprint sensor). According to graph 602 in FIG. 6, a line 621 may indicate, for example, the intensity of light emitted from the display, which is obtained and measured over time. According to graph 602 in FIG. 6, arrows 611, 612, and 613 may indicate exposure times (e.g., the exposure time ET of graph 601) for which three rows among the rows of the fingerprint sensor obtain light, respectively. As shown in graph 602 in FIG. 6, when the exposure time is an integer multiple of a period (e.g., a time a1) during which the display is turned on/off, the number of time intervals for which the display is turned off in each of the exposure times indicated by the arrows 611, 612, and 613 for which three rows obtain light may be identically or exactly four (“4”). Accordingly, when the fingerprint sensor is controlled such that each pixel of the fingerprint sensor obtains light for the exposure time obtained by multiplying, by an integer, a period (e.g., the time a1) during which the display is turned on/off, flicker noise occurring in an image obtained using the fingerprint sensor may be minimized.

In an embodiment, a period during which the display is actually turned on/off may be set by using a clock generated by an oscillator of the electronic device (by multiplying, by an integer, a period of the clock generated by the oscillator). The clock (e.g., the period of the clock) generated by the oscillator may be changed by an external environment of the electronic device (e.g., the temperature of the electronic device, the ambient brightness of the electronic device, and the brightness of the display screen of the electronic device). For example, as shown by a comparison between a graph 601 and a graph 603, as the clock generated by the oscillator is changed, the on/off period of the display (e.g., the period during which the display is actually turned on/off) may be changed from the time a1 to a time a2 shorter than the time a1. However, embodiments are not limited thereto, and as the clock generated by the oscillator is changed, the on/off period of the display may be changed from the time a1 to a time longer than the time a1. Graph 603 may show an example in which, while the actual on/off period of the display is about 3.952 ms (when the refresh rate of the display is about 253 Hz), the exposure time ET is about 16.64 ms obtained by multiplying the initial on/off period (about 4.16 ms) of the display by an integer four (“4”).

In an embodiment, in a comparative example, when the time for which each pixel of the fingerprint sensor is exposed to light is set or selected to be an integer multiple of the period during which the display is turned on/off, and then the clock (e.g., the period of the clock) generated by the oscillator is changed, the time (e.g., the exposure time ET of graph 601 and graph 603) for which each pixel of the fingerprint sensor is exposed to light may not be an integer multiple of the period (e.g., the time a2) during which the display is actually turned on/off. For example, according to graph 604 in FIG. 6, the X-axis may represent time, and the Y-axis may denote the intensity of light. According to graph 604 in FIG. 6, a line 641 may indicate, for example, the intensity of light emitted from the display, which is obtained and measured over time. According to graph 604 in FIG. 6, arrows 614, 615, and 616 may indicate exposure times (e.g., the exposure time ET of graph 601) for which three rows among the rows of the fingerprint sensor obtain light, respectively. As indicated by graph 604 in FIG. 6, if the time (e.g., the exposure time ET of graph 601 and graph 603) for which each pixel of the fingerprint sensor is exposed to light is not an integer multiple of the period (e.g., the time a2) during which the display is actually turned on/off, the number of time intervals for which the display is turned off in each of the exposure times indicated by the arrows 614 and 616 for which two rows obtain light is four (“4”) while the number of time intervals for which the display is turned off in the exposure time 615 for which the remaining row obtains light may be five (“5”). In this case, a pattern caused by flicker noise may be present in an image obtained using the fingerprint sensor.

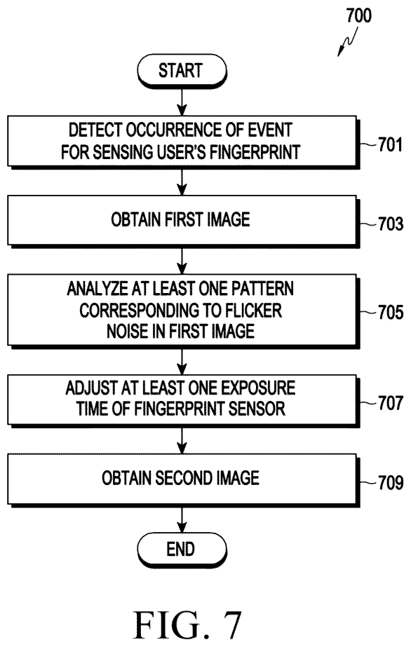

Hereinafter, referring to FIG. 7 through FIG. 22, examples of operations for minimizing flicker noise occurring in an image obtained using the fingerprint sensor even when a clock generated by the oscillator of the electronic device 201 is changed are described in greater detail.

FIG. 7 is a flowchart 700 illustrating a method of controlling the fingerprint sensor 220 according to an embodiment.

In the embodiment described below, operations may be sequentially performed, but embodiments are not limited thereto. For example, the sequence of operations may be changed, and at least two operations may be performed in parallel.

According to an embodiment, it may be understood that operation 701 through operation 709 are performed by a processor (e.g., the processor 240 in FIG. 2) of an electronic device (e.g., the electronic device 201 in FIG. 2).

Referring to FIG. 7, at operation 701, in an embodiment, the processor 240 may detect the occurrence of an event for sensing a fingerprint of a user.

In an embodiment, the processor 240 may display, using the display 210, an image related to a fingerprint (e.g., a fingerprint image for providing a guidance for a position or area on which a user's fingerprint may be input, which may be referred to as “fingerprint icon”, on a position (or in an area) of the display 210 corresponding to a position at (or area in) which the fingerprint sensor 220 is disposed.

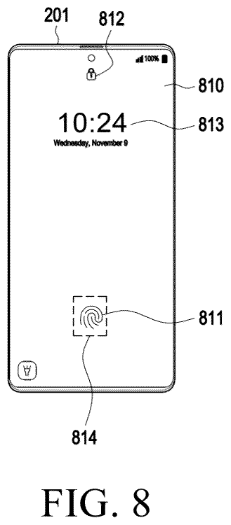

In an embodiment, the processor 240 may obtain a touch input on an area including the fingerprint icon in the display 210, thereby detecting an event for sensing a user's fingerprint. For example, the processor 240 may detect an event generated by a user's touch on an area including the fingerprint icon in the display 210. Hereinafter, with reference to FIG. 8, an example of an operation of detecting an event for sensing a user's fingerprint is described in greater detail.

FIG. 8 is a diagram illustrating a method of detecting an event for sensing a user's fingerprint according to an embodiment.

Referring to FIG. 8, in an embodiment, the processor 240 may display a lock screen using the display 210 while the electronic device 201 is in a locked state. For example, the processor 240 may display, using the display 210, a lock screen 810 including a fingerprint icon 811, an object 812 indicating that the electronic device 201 is in a locked state, and time information 813 while the electronic device 201 is in a locked state.

In an embodiment, the processor 240 may obtain a touch input on an area 814 including the fingerprint icon 811 in the display 210. The processor 240 may detect an event for sensing a user's fingerprint through the acquisition of the touch input. In an embodiment, the touch input may include an input in which a touch on the display 210 is maintained.

In an embodiment, the area 814 including the fingerprint icon 811 may be an area which may cause at least a part of an operation for fingerprint authentication to be performed when a touch input is received on at least a part of the area 814.

In the above examples, an operation of obtaining a touch input on the area 814 including the fingerprint icon 811 while the electronic device 201 is in a locked state is described, but embodiments are not limited thereto. For example, the processor 240 may display a screen including a fingerprint icon using the display 210 during execution of an application requiring fingerprint authentication to perform a function (e.g., a payment application, a bank application, or an application for which fingerprint authentication is set for execution by a user). The processor 240 may obtain a touch input on an area including the fingerprint icon while the screen including the fingerprint icon is being displayed using the display 210. The processor 240 may detect an event for sensing a user's fingerprint through the acquisition of the touch input.

At operation 703, in an embodiment, the processor 240 may, in response to detection of the occurrence of an event for sensing a user's fingerprint, obtain a first image by using the fingerprint sensor 220 before the display 210 emits light at a predetermined intensity to sense the fingerprint.

In an embodiment, the processor 240 may, based on a touch input on the display 210 (e.g., detection of a touch event occurring when a user touches an area including a fingerprint icon), provide, to the display 210, a signal (which may also be referred to as “a first signal”) for allowing the display 210 to emit light set for acquisition of fingerprint information. For example, the processor 240 may, based on a touch input on the display 210, transfer the first signal to the DDI so that the display 210 (e.g., the display panel 211) emits light set for acquisition of fingerprint information (e.g., fingerprint image).

In an embodiment, the light set for acquisition of fingerprint information may be light having a predetermined intensity for sensing a fingerprint (e.g., which may be suitable or sufficient for obtaining an image from which fingerprint information may be detected or extracted). For example, the light having a predetermined intensity for sensing a fingerprint may include light which may enable the display 210 to display a white image at the maximum luminance of the display 210. For example, the light having a predetermined intensity for sensing a fingerprint may include light having an intensity greater than the intensity of light for displaying a fingerprint icon.

In an embodiment, the light set for acquisition of fingerprint information may be light having an intensity equal to or greater than a designated or predetermined intensity.

In an embodiment, the light set for acquisition of fingerprint information may be emitted by pixels (which may also be referred to as “first pixels of the display 210”) arranged at a position (or in an area) corresponding to a position (or area) of the fingerprint sensor 220 among all pixels of the display 210.

In an embodiment, the DDI may, based on reception of the first signal from the processor 240, perform an operation for allowing the display 210 (e.g., the display panel 211) to emit light set for acquisition of fingerprint information. For example, the DDI may, when the first signal is received, perform an operation of obtaining, from the memory, information about the positions of the first pixels of the display 210 and/or the intensity (e.g., a predetermined intensity for sensing a fingerprint) of light set for acquisition of fingerprint information. The DDI may, after performing the operation of obtaining, from the memory, information about the positions of the first pixels of the display 210 and/or the intensity of light set for acquisition of fingerprint information, control the display 210 (e.g., the display panel 211) such that the first pixels of the display 210 emit light having a predetermined intensity for sensing a fingerprint.

In an embodiment, it may take a particular amount of time for the display 210 to emit light set for acquisition of fingerprint information after receiving the first signal from the processor 240. For example, it may take a particular amount of time for the DDI to control the display panel 211 to emit light set for acquisition of fingerprint information, based on obtained information about the positions of the first pixels of the display 210 and/or the intensity of the light, after obtaining the information from the memory, based on reception of the first signal. For example, the display panel 211 may emit light having an intensity equal to or greater than a designated or predetermined intensity at a time point after operation 707 is performed.

In an embodiment, the processor 240 may, based on a touch input on the display 210 (e.g., in response to detection of the occurrence of a touch event occurring when a user touches an area including a fingerprint icon), provide, to the fingerprint sensor 220, a signal (which may also be referred to as “a second signal”) for obtaining a first image using the fingerprint sensor 220.

In an embodiment, the first image may be obtained based on pixel values of the fingerprint sensor 220 obtained from the fingerprint sensor 220 (e.g., generated by the fingerprint sensor 220) before the display 210 emits light set for acquisition of fingerprint information after receiving the first signal from the processor 240.

In an embodiment, the first image may be an image used for adjusting (or determining whether to adjust or maintain) an exposure time (e.g., the time m1 in FIG. 4) for which each row of the pixels of the light sensing area 310 obtains light.

In an embodiment, the first image may not be used for fingerprint authentication. For example, the first image may not be used for acquisition of fingerprint information. Hereinafter, as an image obtained using the fingerprint sensor 220 such as the first image, an image which is not used for fingerprint authentication (e.g., an image for which an operation of extracting feature points is not performed after the image is obtained using the fingerprint sensor 220) may be referred to as a “dummy image”.

In an embodiment, the second signal may include a command for activating the fingerprint sensor 220, a command for allowing the fingerprint sensor 220 to obtain pixel values of the fingerprint sensor 220 (e.g., pixel values of the fingerprint sensor 220 obtained for acquisition of a first image), a command for allowing the fingerprint sensor 220 to obtain pixel values of the fingerprint sensor 220 (e.g., pixel values of the fingerprint sensor 220 obtained for acquisition of a second image to be described later) after the display 210 emits light set for acquisition of fingerprint information (or while the display 210 is emitting the light), and/or an exposure time stored in the memory 230.

In an embodiment, the command for activating the fingerprint sensor 220 may be or may include a command for switching the light sensing area 310, the ADC 320, and the controller 330 included in the fingerprint sensor 220 from an inactive state (e.g., a sleep state) to an active state (e.g., a wakeup state) and supplying power to the light sensing area 310 and the ADC 320.

In an embodiment, the command for allowing the fingerprint sensor 220 to obtain pixel values of the fingerprint sensor 220 may be or may include a command for allowing the activated fingerprint sensor 220 to obtain pixel values of the fingerprint sensor 220 by using the rolling shutter method, so as to obtain a first image.

In an embodiment, the command for allowing the fingerprint sensor 220 to obtain pixel values of the fingerprint sensor 220 after the display 210 emits light set for acquisition of fingerprint information (or while the display is emitting the light) may be or may include a command for allowing the fingerprint sensor 220 to obtain pixel values of the fingerprint sensor 220 for acquisition of a second image (a fingerprint image for acquisition of fingerprint information), as described below with reference to operation 707, after passage of a designated or predetermined time (which may also be referred to as a “delay time”) from a time point at which the second signal is received.

In an embodiment, as described above, it may take a particular amount of time for the display 210 to emit light set for acquisition of fingerprint information after receiving the first signal from the processor 240. The designated or predetermined time (e.g., the delay time) may be a time set for the fingerprint sensor 220 having received the second signal from the processor 240, to obtain pixel values of the fingerprint sensor 220 after the display 210 emits light set for acquisition of fingerprint information or while the display is emitting the light.

In an embodiment, the exposure time stored in the memory 230 may be an exposure time (e.g., an exposure time for which each row of the pixels of the light sensing area 310 obtains light) obtained by multiplying, by an integer, an on/off period of the display 210 corresponding to the refresh rate of the display 210 set at the time of a touch input on the display 210 (e.g., set for the current display 210).

In an embodiment, an on/off period of the display 210 corresponding to the refresh rate of the display 210 may be calculated based on the refresh rate of the display 210 or may be calculated based on the refresh rate of the display 210 and then stored in the memory 230. For example, if the refresh rate of the display 210 set at the time of a touch input on the display 210 (e.g., at the time of a touch input on the area 814 including a fingerprint icon) is 240 Hz, the on/off period of the display 210 may be calculated to be about 4.16 ms. In some embodiments, the on/off period of the display 210 may also be referred to as “an initial on/off period TO of the display 210” or “an on/off period set as a default of the display 210”.

In an embodiment, an exposure time may be obtained by multiplying the on/off period of the display 210 by a designated or predetermined integer (n). For example, if the refresh rate of the display 210 is 240 Hz, the on/off period of the display 210 may be about 4.16 ms. If the designated or predetermined integer (n) is four (“4”), the exposure time may be about 16.64 ms.

In an embodiment, the designated or predetermined integer (n) may be determined to prevent the saturation of the fingerprint sensor 220 (e.g., prevent pixel values of the fingerprint sensor 220 from exceeding a threshold value) by considering the light quantity of the display 210 and/or the sensitivity of the fingerprint sensor 220 in a process stage of the electronic device 201 (e.g., a stage of assembling the electronic device 201). In an embodiment, the designated or predetermined integer (n) and the exposure time may be determined (e.g., calculated) in the process stage of the electronic device 201 and then be stored in the memory 230.

Hereinafter, an exposure time obtained by multiplying the initial on/off period TO of the display 210 by the designated or predetermined integer (n) may also be referred to as an “initial exposure time ET0 of the fingerprint sensor 220” or an “exposure time set as a default of the fingerprint sensor 220”.

In an embodiment, the processor 240 may obtain a first image using the fingerprint sensor 220 before the display 210 emits light set for acquisition of fingerprint information (e.g., light emitted at a predetermined intensity to sense a user's fingerprint). For example, the processor 240 may, before the display 210 emits light set for acquisition of fingerprint information, obtain the first image, based on pixel values sequentially obtained in a unit of rows with respect to pixels included in the fingerprint sensor 220.

In an embodiment, the fingerprint sensor 220 may be activated based on a second signal (e.g., a command for activating the fingerprint sensor 220) received from the processor 240. The activated fingerprint sensor 220 may obtain pixel values of the fingerprint sensor 220 by using the rolling shutter method, based on the initial exposure time ET0 of the fingerprint sensor 220. For example, after the fingerprint sensor 220 is activated, rows of the pixels included in the fingerprint sensor 220 sequentially start an operation of obtaining light according to a designated or predetermined time interval (e.g., the time m3 in FIG. 4), and each of the rows of the pixels included in the fingerprint sensor 220 may obtain light for the initial exposure time ET0 of the fingerprint sensor 220. The fingerprint sensor 220 may perform a readout operation sequentially for the rows of the pixels included in the fingerprint sensor 220 (continuously for the rows of the pixels included in the fingerprint sensor 220 for the time m2 in FIG. 4 with respect to each of the rows of the pixels included in the fingerprint sensor 220), thereby obtaining pixel values of the fingerprint sensor 220. In an embodiment, the fingerprint sensor 220 (e.g., the controller 330) may transfer the obtained pixel values of the fingerprint sensor 220 to the processor 240.

In an embodiment, the processor 240 may obtain a first image, based on the pixel values of the fingerprint sensor 220 received from the fingerprint sensor 220. For example, the processor 240 may generate a first image (e.g., a dummy image) having pixel values corresponding to the pixel values of the fingerprint sensor 220.

In an embodiment, the processor 240 may generate a first image such that the number of the pixels of the fingerprint sensor 220 is equal to the number of the pixels of the first image and the pixel values of the first image correspond to the pixel values of the fingerprint sensor 220. For example, when the number of the pixels of the fingerprint sensor 220 is 200×200 (e.g., when the light sensing area 310 includes 200 pixels in the widthwise direction and 200 pixels in the lengthwise direction), the processor 240 may generate a first image having 200×200 pixels wherein the pixel values at the positions of the pixels of the fingerprint sensor 220 correspond to the pixel values at the positions of the pixels in the first image corresponding to the positions.

In an embodiment, the processor 240 may generate a first image such that the number of the pixels of the fingerprint sensor 220 is different from the number of the pixels of the first image and the pixel values of the first image correspond to the pixel values of the fingerprint sensor 220. For example, when the number of the pixels of the fingerprint sensor 220 is 200×200, the processor 240 may perform a binning operation (e.g., an operation of grouping every 2×2 pixels into one pixel with respect to the 200×200 pixels) for the values of the pixels of the fingerprint sensor 220, thereby generating a first image having 100×100 pixels. In this case, the pixel values at the positions (e.g., coordinates (1,1), coordinates (1,2), coordinates (2,1), and coordinates (2,2) in the light sensing area 310) of the pixels of the fingerprint sensor 220 may correspond to the pixel values at the corresponding positions (e.g., coordinates (1,1) of the first image) of the pixels in the first image, respectively.

In an embodiment, in the above examples, a first image having pixel values corresponding to the pixel values of the fingerprint sensor 220 is described as being generated based on the pixel values of the fingerprint sensor 220 received from the fingerprint sensor 220, but embodiments are not limited thereto. In an embodiment, the processor 240 may set, as a first image, the pixel values of the fingerprint sensor 220 received from the fingerprint sensor 220. For example, data of the first image may include the pixel values of the fingerprint sensor 220 received from the fingerprint sensor 220.

At operation 705, in an embodiment, the processor 240 may analyze at least one pattern corresponding to flicker noise in the first image.

In an embodiment, flicker noise may occur when an exposure time (e.g., the initial exposure time ET0 of the fingerprint sensor 220) for which each row of the pixels of the fingerprint sensor 220 obtains light does not match a time obtained by multiplying, by an integer (n), the period during which the display 210 is actually turned on/off.

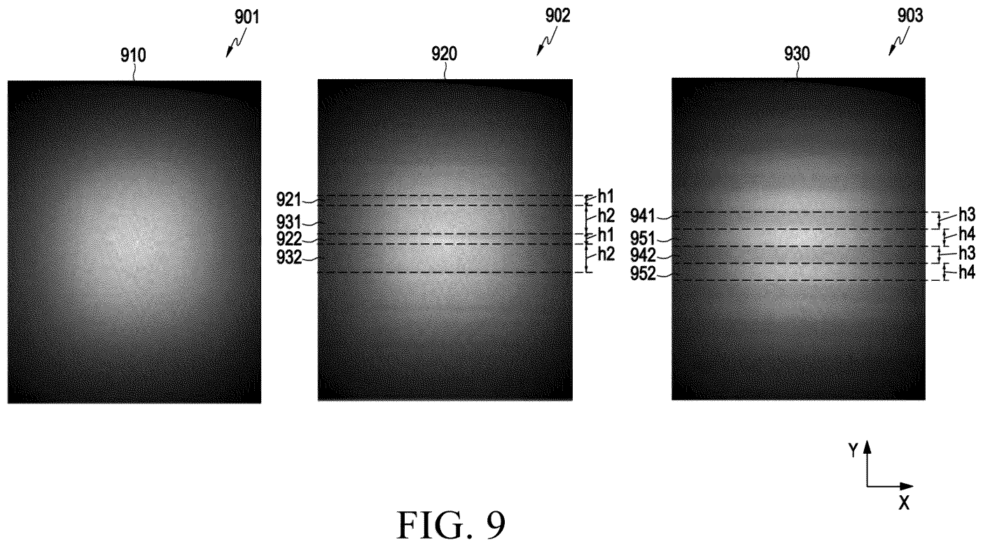

In an embodiment, when flicker noise occurs in a first image, the first image (e.g., a dummy image) may include a pattern (which may be referred to as a “pattern”) in which a first portion (e.g., a relatively bright band) and a second portion darker than the first portion (e.g., a relatively dark band) appear alternatingly and repeatedly. In embodiments, the first portion may be referred to as a “first component generated by flicker noise”, and the second portion may be referred to as a “second component generated by flicker noise”. Hereinafter, with reference to FIG. 9, an example of a pattern caused by flicker noise in a first image is described in greater detail.

FIG. 9 is a diagram illustrating a pattern caused by flicker noise in a first image according to an embodiment.

Referring to FIG. 9, in an embodiment, the +X-axis may correspond to the direction of rows of the pixels of the first image (e.g., the direction in which pixels of the same row are arranged) and the −Y-axis may correspond to the column direction of the pixels of the first image (e.g., the direction in which pixels of the same column are arranged).

As shown in example 901, when flicker noise does not occur, the pattern may not appear in a first image 910.

As shown in example 902, when flicker noise occurs in a first image 920, a first portion and a second portion may appear alternatingly and repeatedly in the column direction of the pixels of the first image 920, such as first portions 931 and 932 and second portions 921 and 922, in the first image 920. For example, the first portion and the second portion in the first image 920 may be alternatingly repeated in the column direction of the pixels of the first image 920. Each of the first portion and the second portion may be a band appearing in the row direction of the pixels of the first image 920 in the first image 920.

In an embodiment, an interval (which may also be referred to as a “pattern interval”) at which the first portion or the second portion appears repeatedly in the first image may be the same. For example, as indicated by example 902, the height of each of the first portions 931 and 932 are the same as h2, and the height of each of the second portions 921 and 922 may be the same as h1. An interval (e.g., the difference between the position at which the first portion 931 starts and the position at which the first portion 932 starts in the column direction of the first image 920) between the first portions 931 and 932 in the first image 920 may be a height obtained by summing h1 and h2. An interval (e.g., the difference between the position at which the second portion 921 starts and the position at which the second portion 922 starts in the column direction of the first image 920) between the second portions 921 and 922 in the first image 920 may also be a height obtained by summing h1 and h2.

In an embodiment, according to the difference (hereinafter, referred to as an “offset of the on/off period”) between the initial on/off period TO of the display 210 and the actual on/off period of the display 210 (e.g., the period during which the display 210 is actually turned on/off), the pattern interval at which the first portion or the second portion appears repeatedly in the first image may differ. As shown in example 903, when flicker noise occurs in a first image 930, a first portion and a second portion may appear alternatingly and repeatedly in the column direction of the pixels of the first image 930, such as first portions 951 and 952 and second portions 941 and 942, in the first image 930. A pattern interval (e.g., a height obtained by summing a height h3 and a height h4) at which the first portion or the second portion appears repeatedly in the first image 930 may be the same. However, as shown by a comparison between the first image 920 and the first image 930, when the offset of the on/off period generated when the first image 920 is obtained differs from the offset of the on/off period generated when the first image 930 is obtained, the pattern interval of the first image 920 may be a height obtained by summing a height h1 and a height h2, and the pattern interval of the first image 930 may be a height obtained by summing the height h3 and the height h4, which may be different from the height obtained by summing the height h1 and the height h2.

At operation 707, in an embodiment, the processor 240 may adjust at least one exposure time of the fingerprint sensor 220 for sensing light obtained by reflection, by the fingerprint of the user, of light emitted by the display 210 at the predetermined intensity, based on the analysis (e.g., an operation of analyzing at least one pattern corresponding to flicker noise in the first image of operation 705).

In an embodiment, the light obtained by reflection, by the fingerprint of the user, of light emitted by the display 210 at the predetermined intensity may include light obtained by reflection, by the fingerprint touching the display 210, of light emitted by the display 210 at a predetermined intensity to sense a user's fingerprint.

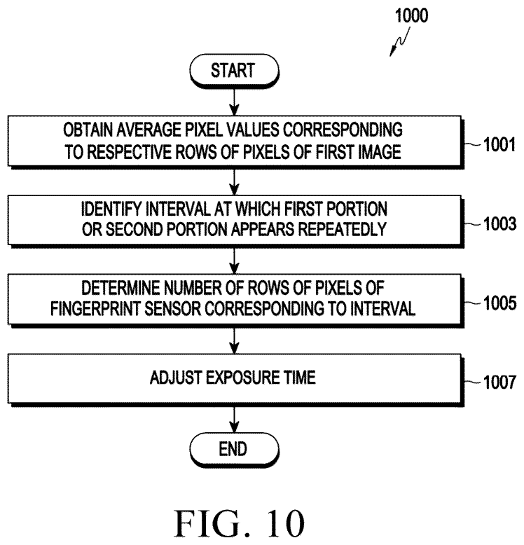

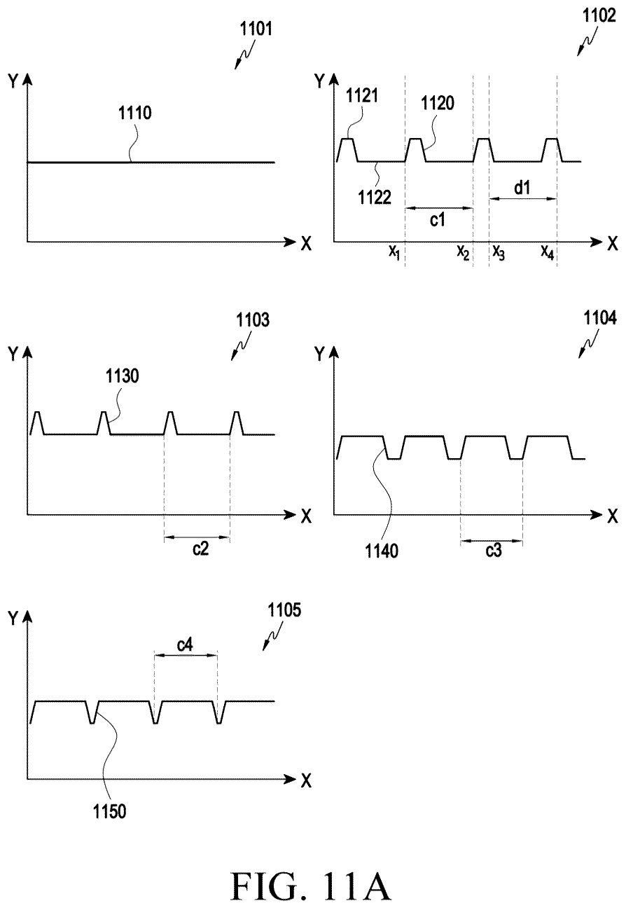

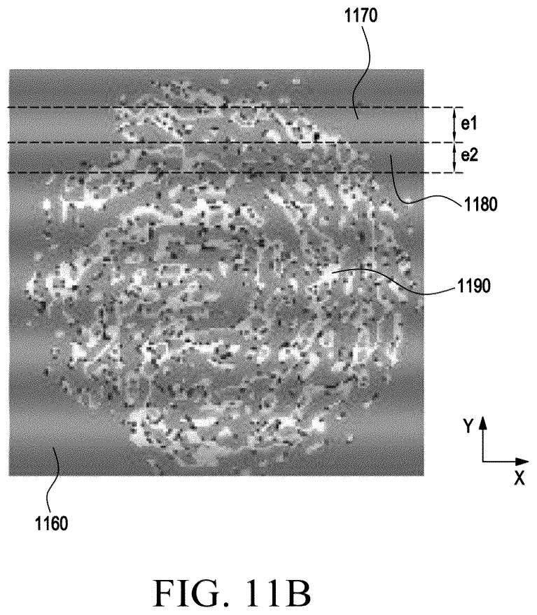

In an embodiment, the processor 240 may adjust an exposure time (e.g., the initial exposure time ET0 of the fingerprint sensor 220) for which each row of the pixels of the fingerprint sensor 220 obtains light, based on a pattern caused by flicker noise (at least one pattern corresponding to flicker noise) in a first image. For example, the processor 240 may determine an adjusted exposure time (which may be referred to as an adjusted exposure timeET1 of the fingerprint sensor 220) for which each row of the pixels of the fingerprint sensor 220 is to obtain light, based on at least one pattern corresponding to flicker noise occurring in a first image. Hereinafter, with reference to FIG. 10, FIG. 11A, and FIG. 11B, examples of an operation of adjusting an exposure time of the fingerprint sensor 220, based on analysis of at least one pattern corresponding to flicker noise in a first image are described.

FIG. 10 is a flowchart 1000 illustrating a method of adjusting an exposure time according to an embodiment.

FIG. 11A is a diagram illustrating a method of adjusting an exposure time according to an embodiment.

FIG. 11B is a diagram illustrating a method of adjusting an exposure time according to an embodiment.

In the embodiment described below, operations may be sequentially performed, but embodiments are not limited thereto. For example, the sequence of operations may be changed, and at least two operations may be performed in parallel.

According to an embodiment, it may be understood that operation 1001 through operation 1007 are performed by a processor (e.g., the processor 240 in FIG. 2) of an electronic device (e.g., the electronic device 201 in FIG. 2).

In an embodiment, operation 1001 through operation 1005 may be included in operation 705 of FIG. 7, and operation 1007 may be included in operation 707 of FIG. 7. However, embodiments are not limited thereto. For example, operation 1001 and operation 1003 may be included in operation 705 of FIG. 7, and operation 1005 and operation 1007 may be included in operation 707 of FIG. 7.

Referring to FIG. 10, FIG. 11A, and FIG. 11B, at operation 1001, in an embodiment, the processor 240 may obtain average pixel values corresponding to respective rows of pixels of a first image. For example, the processor 240 may calculate an average value (which may also be referred to as an “average pixel value of a row”) of the pixel values of the pixels included in a row with respect to each row of the pixels of the first image.

At operation 1003, in an embodiment, the processor 240 may identify an interval (e.g., a pattern interval) at which a first portion or a second portion appears repeatedly in the first image, based on the obtained average pixel values corresponding to the respective rows of pixels of the first image. Hereinafter, with reference to FIGS. 11A and 11B, examples of an operation of identifying a pattern interval at which a first portion or a second portion appears repeatedly in a first image are described.

In an embodiment, in FIG. 11A, the X-axis may represent rows according to an order (e.g., an order from the uppermost row to the lowermost row in the first image) in which the rows are arranged for the pixels of the first image, and the Y-axis may denote average pixel values.

In an embodiment, a line 1110 in a graph 1101 in FIG. 11A may indicate average pixel values of rows of the pixels of the first image according to the rows of the pixels of the first image when flicker noise does not occur in the first image. As noted by the line 1110 of graph 1101, when flicker noise does not occur in the first image, the average pixel values (e.g., Y-axis values of the line 1110) of the rows of the pixels of the first image may be substantially the same.

In an embodiment, graph 1102 of FIG. 11A may show an example in which an offset of the on/off period is about +5% (e.g., the actual on/off period of the display 210 is about 95% of the initial on/off period TO of the display 210). A line 1120 in a graph 1102 may indicate average pixel values of rows of the pixels of the first image according to the rows of the pixels of the first image (e.g., according to an order of the rows being arranged for the pixels of the first image) when flicker noise occurs in the first image. In the line 1120, a value 1121 may be a maximum value among the average pixel values in the first image, and a value 1122 may be a minimum value among the average pixel values in the first image. Rows having maximum average pixel values in the first image (e.g., the rows on the X-axis corresponding to a maximum value 1121 among the average pixel values) are included in a first portion (e.g., a first portion of a pattern generated by flicker noise), and rows having minimum average pixel values in the first image (e.g., the rows on the X-axis corresponding to a minimum value 1122 among the average pixel values) may be included in a second portion (e.g., a second portion of a pattern generated by flicker noise).

In an embodiment, graph 1103 of FIG. 11A may show an example in which an offset of the on/off period is about +2.5% (e.g., the actual on/off period of the display 210 is about 97.5% of the initial on/off period TO of the display 210). A line 1130 in a graph 1103 may indicate average pixel values of rows of the pixels of the first image according to the rows of the pixels of the first image when flicker noise occurs in the first image.

In an embodiment, graph 1104 of FIG. 11A may show an example in which an offset of the on/off period is about-5% (e.g., the actual on/off period of the display 210 is about 105% of the initial on/off period TO of the display 210). A line 1140 in graph 1104 may indicate average pixel values of rows of the pixels of the first image according to the rows of the pixels of the first image when flicker noise occurs in the first image.

In an embodiment, graph 1105 of FIG. 11A may show an example in which an offset of the on/off period is about-2.5% (e.g., the actual on/off period of the display 210 is about 102.5% of the initial on/off period TO of the display 210). A line 1150 in a graph 1105 may indicate average pixel values of rows of the pixels of the first image according to the rows of the pixels of the first image when flicker noise occurs in the first image.

In an embodiment, the processor 240 may identify a pattern interval at which a first portion or a second portion appears repeatedly, based on the average pixel values of the rows of pixels of the first image. For example, the processor 240 may identify, as a pattern interval at which a first portion or a second portion appears repeatedly, the number of rows of the first image corresponding to the pattern interval at which the first portion or the second portion appears repeatedly.

In an embodiment, as described above, a pattern interval at which a first portion appears repeatedly and a pattern interval at which a second portion appears repeatedly, in the first image, may be the same. In an embodiment, the pattern interval may be the same as the number of rows in a section in which the average pixel values of the rows of the pixels of the first image are repeated, in each of the lines (e.g., the line 1120, the line 1130, the line 1140, and the line 1150) of the graphs in FIG. 11A. For example, as indicated by graph 1102, the pattern interval may be the same as the number of rows in a section c1 (or the number of rows in a section d1) among sections in which the average pixel values of the rows of the pixels of the first image are repeated. The section c1 may include rows from a row x1 at which the average pixel values of the rows of the pixels of the first image start to increase, through a row immediately before a row x2 at which the average pixel values start to increase again. The section d1 may include rows from a row x3 at which the average pixel values of the rows of the pixels of the first image start to decrease, through a row immediately before a row x4 at which the average pixel values start to decrease again. For example, as indicated by graph 1103, the pattern interval may be the same as the number of rows in a section c2 in which the average pixel values of the rows of the pixels of the first image are repeated. For example, as indicated by graph 1104, the pattern interval may be the same as the number of rows in a section c3 in which the average pixel values of the rows of the pixels of the first image are repeated. For example, as indicated by graph 1105, the pattern interval may be the same as the number of rows in a section c4 in which the average pixel values of the rows of the pixels of the first image are repeated.

In an embodiment, the processor 240 may identify a pattern interval at which a first portion or a second portion appears repeatedly in a first image by identifying the number of rows in a section in which the average pixel values of the rows of the pixels of the first image are repeated according to the rows of the pixels of the first image in the first image (e.g., according to an order in which the rows are arranged for the pixels of the first image).

In an embodiment, a first image may include not only a pattern caused by flicker noise but also a part corresponding to a fingerprint (e.g., a part shown by touching the display 210 with the fingerprint) and a part corresponding to a fingerprint icon image (e.g., a part shown by the fingerprint icon image). The part corresponding to a fingerprint and the part corresponding to a fingerprint icon image included in a first image may not affect the deviation (e.g., standard deviation) of average pixel values corresponding to respective rows of the pixels of the first image. For example, in FIG. 11B, a first image 1160 may include first portions (e.g., a first portion 1170) and second portions (e.g., a second portion 1180) caused by flicker noise, and a part 1190 corresponding to a fingerprint icon image. When an average pixel value for each row of the pixels of the first image is calculated, pixel values caused by the part 1190 corresponding to the fingerprint icon image and reflected on the average pixel values of the respective rows of the pixels of the first image may be substantially the same. Accordingly, when an interval at which a first portion or a second portion appears repeatedly in a first image is identified, an effect of a part corresponding to a fingerprint icon image may be disregarded.

In an embodiment, in FIG. 11B, the processor 240 may identify a pattern interval (e.g., a height obtained by summing a height e1 and a height e2) at which the first portion 1170 or the second portion 1180 appears repeatedly in the first image 1160, using the operations described above.

At operation 1005, in an embodiment, the processor 240 may determine the number of rows of pixels of the fingerprint sensor 220 (which may also be to as “the number of rows of pixels of the fingerprint sensor 220 corresponding to a pattern interval”) corresponding to an interval (e.g., pattern interval) (e.g., the number of rows of pixels of the first image corresponding to the pattern interval) obtained through operation 1003.

In an embodiment, when a first image is generated such that the number of the pixels of the fingerprint sensor 220 is the same as the number of the pixels of the first image and the pixel values of the first image correspond to the pixel values of the fingerprint sensor 220, the processor 240 may determine the number of rows of pixels of the first image corresponding to a pattern interval as the number of rows of pixels of the fingerprint sensor 220 corresponding to the pattern interval. For example, when a first image is generated such that the number of the pixels of the fingerprint sensor 220 is the same as the number of the pixels of the first image and the pixel values of the first image correspond to the pixel values of the fingerprint sensor 220, the number of rows of pixels of the first image corresponding to a pattern interval may be the same as the number of rows of pixels of the fingerprint sensor 220 corresponding to the pattern interval.

In an embodiment, when a first image is generated by performing a binning operation for the pixel values of the fingerprint sensor 220, the processor 240 may determine the number of pixels of the fingerprint sensor 220 corresponding to a pattern interval, based on the number of rows in each section in which the average pixel values of the rows of the pixels of the first image are repeated in the first image, and the number of rows of the fingerprint sensor 220 having been used in the binning operation for grouping pixel values of the fingerprint sensor 220. For example, when the processor 240 obtains a first image of 100×100 by performing a binning operation of grouping every 2×2 pixels into one pixel for 200×200 pixels of the fingerprint sensor 220, the processor 240 may determine, as the number of rows of pixels of the fingerprint sensor 220 corresponding to a pattern interval, a value obtained by multiplying, by two (“2”) (e.g., the number of rows of 2×2 pixels), the number of rows in each section in which the average pixel values of the rows of the pixels of the first image are repeated in the first image.

In an embodiment, when the pixel values of the fingerprint sensor 220 received from the fingerprint sensor 220 are set as a first image (e.g., when the pixel values of the fingerprint sensor 220 are included in data of the first image without any change), the processor 240 may identify the number of rows of pixels of the first image corresponding to a pattern interval to be the number of rows of pixels of the fingerprint sensor 220 corresponding to the pattern interval.

At operation 1007, in an embodiment, the processor 240 may adjust an exposure time of the fingerprint sensor 220, based on the number of pixels of the fingerprint sensor 220 corresponding to a pattern interval, a transfer time, and a designated or predetermined integer (n).

In an embodiment, the transfer time (e.g., the readout time) may be a time (e.g., the time m2 in FIG. 4) for which a readout operation is performed for each row of the pixels of the light sensing area 310. The designated or predetermined integer (n) may be a value having been used to obtain (e.g., calculate) the initial exposure time ET0 of the fingerprint sensor 220 from the initial on/off period TO of the display 210.

In an embodiment, a value obtained by multiplying the transfer time and the number of the pixels of the fingerprint sensor 220 corresponding to the pattern interval may be substantially the same as an actual on/off period of the display 210. The processor 240 may determine the value obtained by multiplying the transfer time and the number of the pixels of the fingerprint sensor 220 corresponding to the pattern interval, as an adjusted on/off period of the display 210 (which may also be referred to as an “adjusted on/off period T0′ of the display 210”) for determining an adjusted exposure time of the fingerprint sensor 220.

In an embodiment, the processor 240 may determine, as an adjusted exposure time ET1 of the fingerprint sensor 220, a value (e.g., the number of the pixels of the fingerprint sensor 220 multiplied by the transfer time multiplied by the designated or predetermined integer (n)) obtained by multiplying the number of the pixels of the fingerprint sensor 220 corresponding to the pattern interval, the transfer time, and the designated or predetermined integer (n). For example, the processor 240 may adjust the exposure time of the fingerprint sensor 220 from the initial exposure time ET0 to the determined exposure time ET1.

Referring to FIG. 7, at operation 709, in an embodiment, the processor 240 may obtain a second image using the fingerprint sensor 220 by sensing light obtained by reflection, by the fingerprint of the user, of light emitted by the display 210 at the predetermined intensity, based on the adjusted at least one exposure time.

In an embodiment, the processor 240 may obtain a second image used to obtain fingerprint information by controlling the fingerprint sensor 220 such that each row of the pixels of the fingerprint sensor 220 obtains light for the adjusted exposure time while the display 210 emits the light.

In an embodiment, an operation in which the processor 240 controls the fingerprint sensor 220 such that each row of the pixels of the fingerprint sensor 220 obtains light for the adjusted exposure time may include an operation in which the processor 240 provides, to the fingerprint sensor 220 (e.g., the controller 330), the adjusted exposure time ET1 (e.g., the adjusted exposure time ET1 of the fingerprint sensor 220 determined in operation 1007). However, embodiments are not limited thereto. For example, the fingerprint sensor 220 may receive, from the processor 240, a second signal not including a command, described with reference to operation 703, for allowing the fingerprint sensor 220 to obtain pixel values of the fingerprint sensor 220 while the display 210 is emitting light set for acquisition of fingerprint information or after the display emits the light. In this case, the processor 240 may, when providing the adjusted exposure time ET1 to the fingerprint sensor 220 (e.g., the controller 330), transfer, to the fingerprint sensor 220 together with the adjusted exposure time ET1, a command for instructing acquisition of pixel values of the fingerprint sensor 220, based the adjusted exposure time ET1 while the display 210 is emitting light set for acquisition of fingerprint information or after the display emits the light.

In an embodiment, the processor 240 may compare the adjusted exposure time ET1 and the initial exposure time ET0 of the fingerprint sensor 220. When the difference between the adjusted exposure time ET1 and the initial exposure time ET0 is equal to or longer than a designated or predetermined time, the processor 240 may transfer the adjusted exposure time ET1 to the fingerprint sensor 220. When the difference between the adjusted exposure time ET1 and the initial exposure time ET0 is shorter than the designated or predetermined time, the processor 240 may transfer the initial exposure time ET0 to the fingerprint sensor 220, or not transfer the adjusted exposure time ET1 and the initial exposure time ET0 to the fingerprint sensor 220.

In an embodiment, the display 210 (e.g., DDI) may, based on the first signal received at operation 703, control the display 210 (e.g., the display panel 211) such that the display 210 (e.g., the display panel 211) emits light set for acquisition of fingerprint information (e.g., light emitted at a predetermined intensity for sensing a fingerprint).

In an embodiment, while the display 210 is emitting the light (e.g., light set for acquisition of fingerprint information), or after the display emits the light, the fingerprint sensor 220 may perform an operation of obtaining pixel values of the fingerprint sensor 220, based on the adjusted exposure time ET1, after passage of a designated or predetermined time (e.g., a delay time) from a time point at which a second signal is received from the processor 240, based on the second signal (e.g., a command, described with reference to operation 703, for allowing the fingerprint sensor 220 to obtain pixel values of the fingerprint sensor 220 while the display 210 is emitting light set for acquisition of fingerprint information or after the display emits the light). For example, each pixel of the fingerprint sensor 220 may obtain light (e.g., light including external light and light set for acquisition of fingerprint information) for the adjusted exposure time ET1, whereby the fingerprint sensor 220 may sequentially obtain pixel values of the fingerprint sensor 220 in a unit of rows with respect to the rows of the pixels of the fingerprint sensor 220.

In an embodiment, the fingerprint sensor 220 may transfer the obtained pixel values of the fingerprint sensor 220 to the processor 240. The processor 240 may obtain (e.g., generate) a second image, based on the pixel values of the fingerprint sensor 220 received from the fingerprint sensor 220.

In an embodiment, the processor 240 may, after obtaining a second image, perform a pre-processing operation for obtaining (e.g., extracting) fingerprint information (e.g., feature points of the fingerprint) from the second image. For example, the processor 240 may perform an operation of removing noise (e.g., noise generated by an external light source, noise generated by foreign material existing at the fingerprint sensor 220, and pattern noise generated by a structure of the display 210) other than the fingerprint through pre-training and a stored filter, an operation of re-shaping and re-sizing a second image by considering a shading effect of a lens (e.g., the lens 222), and/or an operation of making a second image be clear.

In an embodiment, the processor 240 may perform an operation of extracting feature points for a preprocessed second image. For example, the processor 240 may perform, for the preprocessed second image, a directional component extraction operation, a binarization operation, an equalization operation, a thinning operation, and/or an operation of extracting feature points (e.g., minutiae). The feature points may include a core point, a delta point, an ending point, and/or a bifurcation point that configure ridges of a fingerprint.

In an embodiment, the processor 240 may compare fingerprint information of a second image (e.g., a second image having been subjected to an operation of extracting feature points) with registered fingerprint information, thereby performing an operation (which may also be referred to as a “matching operation”) of determining whether authentication of a user succeeds or fails. For example, the processor 240 may compare feature points extracted from a second image with feature points (e.g., feature points included in fingerprint information stored in the memory 230 for fingerprint authentication) of registered fingerprint information. The processor 240 may compare feature points of a second image with feature points of registered fingerprint information, thereby calculating a degree of similarity (e.g., a similarity score) between the second image and the registered fingerprint information. The processor 240 may, when the degree of similarity is equal to or greater than a threshold similarity degree, determine that authentication of a user has succeeded. The processor 240 may, when the degree of similarity is smaller than the threshold similarity degree, determine that authentication of a user has failed.

In an embodiment, the processor 240 may, based on a touch input on the display 210 being released (e.g., in response to release of a touch input on an area including a fingerprint icon), control the display 210 not to perform an operation of emitting, by the display 210, light set for acquisition of fingerprint information (e.g., light having an intensity equal to or greater than a designated or predetermined intensity), or to stop the operation of emitting, by the display 210, the light having an intensity equal to or greater than the designated or predetermined intensity.

In an embodiment, the processor 240 may perform an operation for fingerprint authentication, based on the adjusted exposure time ET1 and then not store the adjusted exposure time ET1 in the memory 230. For example, the processor 240 may, after the adjusted exposure time ET1 is determined, store the determined adjusted exposure time ET1 in the memory 230. The processor 240 may perform an operation for fingerprint authentication, based on the adjusted exposure time ET1 and then remove the adjusted exposure time ET1 from the memory 230. However, embodiments are not limited thereto. In an embodiment, the processor 240 may, even after performing an operation for fingerprint authentication, based on the adjusted exposure time ET1, not remove the adjusted exposure time ET1 stored in the memory 230.

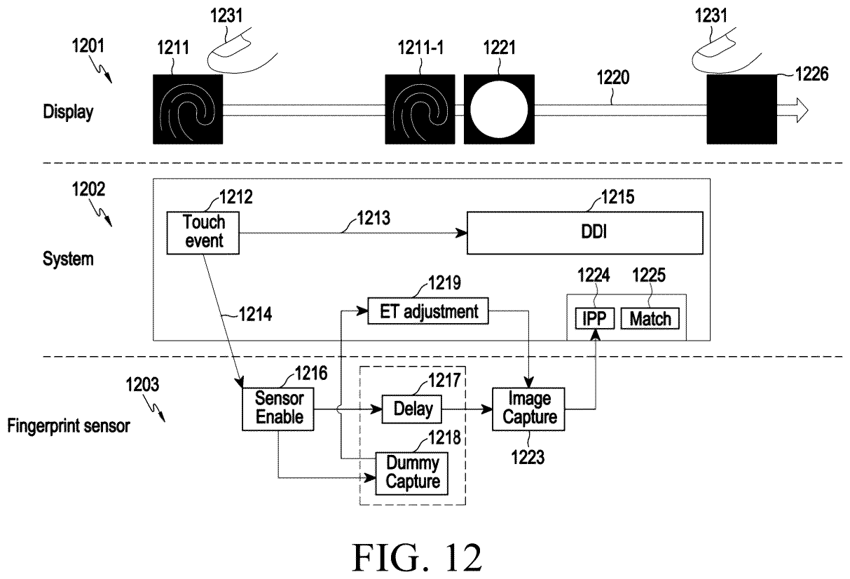

FIG. 12 is a diagram illustrating a method of controlling the fingerprint sensor 220 according to an embodiment.

Referring to FIG. 12, in an embodiment, in FIG. 12, a process 1201 may be performed by the display 210 (e.g., the display panel 211), a process 1202 may be performed by a system (e.g., a processor or DDI), and a process 1203 may be performed by the fingerprint sensor 220. In an embodiment, an arrow 1220 in FIG. 12 may indicate time (e.g., the passage of time).

In an embodiment, the display 210 may display a fingerprint icon at operation 1211. The fingerprint icon may be continuously displayed from operation 1211 through operation 1211-1 until light used for acquisition of fingerprint information is emitted at operation 1221. The intensity of light emitted from the display 210 to display the fingerprint icon at operation 1211 may be smaller than or less than the intensity of light used for acquisition of fingerprint information at operation 1211.

In an embodiment, the processor 240 may detect an event at operation 1212 (illustrated as “Touch event”) for sensing a user's fingerprint, based on a touch input on the display 210 by the user's finger 1231 while the fingerprint icon is being displayed using the display 210 at operation 1211.

In an embodiment, the processor 240 may, based on the detection of the event, provide a first signal 1213 to the DDI, and provide a second signal 1214 to the fingerprint sensor 220.

In an embodiment, the fingerprint sensor 220 may be activated based on reception of the second signal 1213 at operation 1216 (illustrated as “Sensor Enable”).

In an embodiment, during a designated or predetermined time (e.g., a delay time) from a time point at which the fingerprint sensor 220 receives a command included in the second signal 1213 (e.g., a command for allowing the fingerprint sensor 220 to obtain pixel values of the fingerprint sensor 220 after the display 210 emits light set for acquisition of fingerprint information), an operation of obtaining a second image by the fingerprint sensor 220 may be delayed at operation 1217 (illustrated as “Delay”).

In an embodiment, the fingerprint sensor 220 may obtain a first image (e.g., a dummy image) at operation 1218 (illustrated as “Dummy Capture”).

In an embodiment, at operation 1219, the processor 240 may adjust at least one exposure time ET of the fingerprint sensor 220, based on analysis of at least one pattern corresponding to flicker noise in the first image. For example, the processor may adjust the at least one exposure time ET of the fingerprint sensor 220 from an initial exposure time ET0 to an adjusted exposure time ET1 based on the pattern analysis.

In an embodiment, as the DDI may control the display 210 to emit light set for acquisition of fingerprint information, based on reception of the first signal. For example, the display 210 may emit, under control of the DDI, light set for acquisition of fingerprint information (e.g., light having a predetermined intensity for sensing a fingerprint) at operation 1221. For example, the display 210 may emit light enabling a white image to be displayed at the maximum luminance of the display 210.

In an embodiment, the fingerprint sensor 220 may obtain a second image after the display 210 emits the light set for acquisition of fingerprint information (e.g., light having a predetermined intensity for sensing a fingerprint) at operation 1223 (illustrated as “Image Capture”).

In an embodiment, the processor 240 may, after receiving the second image from the fingerprint sensor 220, perform a pre-processing operation, which may be referred to as image pre-processing (IPP), for obtaining (e.g., extracting) fingerprint information (e.g., feature points of the fingerprint) from the second image at operation 1224 (illustrated as “IPP”). In addition, the processor 240 may compare the fingerprint information extracted from the second image with registered fingerprint information, thereby performing a matching operation 1225 (illustrated as “Match”) of determining whether authentication of the user is successful or fails.

In an embodiment, when the touch input on the display 210 by the user's finger 1231 is released, the display 210 may be turned off at operation 1226.

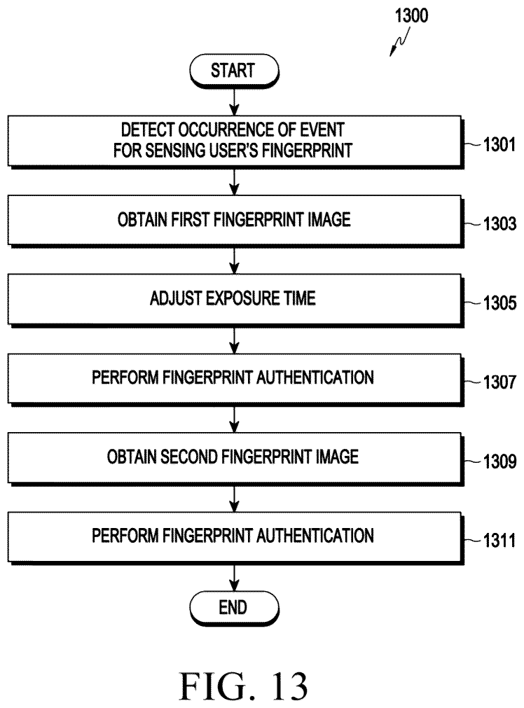

FIG. 13 is a flowchart 1300 illustrating a method of controlling the fingerprint sensor 220 according to an embodiment.

In the embodiment described below, operations may be sequentially performed, but embodiments are not limited thereto. For example, the sequence of operations may be changed, and at least two operations may be performed in parallel.

According to an embodiment, it may be understood that operation 1301 through operation 1311 are performed by a processor (e.g., the processor 240 in FIG. 2) of an electronic device (e.g., the electronic device 201 in FIG. 2).

In an embodiment, in the above examples, an adjusted exposure time ET1 is described as being determined based on a dummy image (e.g., first image) and an operation for fingerprint authentication (e.g., a fingerprint authentication operation based on a second image) is performed based on the adjusted exposure time ET1, but embodiments are not limited thereto. For example, the processor 240 may perform an operation of determining the adjusted exposure time ET1 while performing a fingerprint authentication operation (or together with the fingerprint authentication operation). Hereinafter, with reference to FIG. 13, an example of an operation of determining the adjusted exposure time ET1 while performing a fingerprint authentication operation is described.

Referring to FIG. 13, at operation 1301, the processor 240 may detect the occurrence of an event for sensing a fingerprint of a user.

In an embodiment, the processor 240 may obtain a touch input on the display 210. In an embodiment, the processor 240 may detect the occurrence of an event for sensing a fingerprint of a user, based on a touch input on the display 210 being obtained.

In an embodiment, the processor 240 may display, using the display 210, a fingerprint icon on a position (or in an area) of the display 210 corresponding to a position at (or area in) which the fingerprint sensor 220 is disposed. The processor 240 may obtain (e.g., receive) a touch input on an area including the fingerprint icon in the display 210, thereby detecting the occurrence of an event for sensing a user's fingerprint.

At operation 1303, in an embodiment, the processor 240 may, in response to detection of the occurrence of an event for sensing a user's fingerprint, obtain a first image by using the fingerprint sensor 220.

In an embodiment, the processor 240 may, based on a touch input on the display 210, provide, to the display 210, a first signal for allowing the display 210 to emit light set for acquisition of fingerprint information, and provide, to the fingerprint sensor 220, a third signal for obtaining, using the fingerprint sensor 220, an image (which may be referred to as a “first fingerprint image”) to be used for acquisition of fingerprint information.

In an embodiment, an operation of providing to the display 210, based on a touch input on the display 210, a first signal for allowing the display 210 to emit light set for acquisition of fingerprint information (e.g., light emitted at a predetermined intensity for sensing a fingerprint) is described with reference to operation 703 of FIG. 7, and redundant or duplicative description thereof may be omitted.

In an embodiment, the third signal may include a command for activating the fingerprint sensor 220, a command for allowing the fingerprint sensor 220 to obtain pixel values of the fingerprint sensor 220 after the display 210 emits light set for acquisition of fingerprint information (or while the display is emitting the light), and/or an exposure time (e.g., an initial exposure time ET0 of the fingerprint sensor 220) stored in the memory 230.

In an embodiment, the processor 240 may obtain a first fingerprint image using the fingerprint sensor 220 after the display 210 emits light set for acquisition of fingerprint information (or while the display is emitting the light).

In an embodiment, the fingerprint sensor 220 may, based on the third signal received from the processor 240, obtain pixel values of the fingerprint sensor 220 after the display 210 emits light set for acquisition of fingerprint information. For example, the fingerprint sensor 220 may, based on the third signal received from the processor 240, obtain pixel values of the fingerprint sensor 220 using the rolling shutter method after the display 210 emits light set for acquisition of fingerprint information. The fingerprint sensor 220 may transfer the obtained pixel values of the fingerprint sensor 220 to the processor 240.

In an embodiment, the processor 240 may obtain a first fingerprint image, based on the pixel values of the fingerprint sensor 220 received from the fingerprint sensor 220.

At operation 1305, in an embodiment, the processor 240 may adjust an exposure time of the fingerprint sensor 220, based on the first fingerprint image.

In an embodiment, the processor 240 may analyze at least one pattern corresponding to flicker noise in the first fingerprint image. The processor 240 may, based on the analysis, adjust at least one exposure time of the fingerprint sensor 220 for sensing light obtained by reflection, by the fingerprint of the user, of light emitted by the display 210 at the predetermined intensity.

In an embodiment, the processor 240 may determine an adjusted on/off period T0′ and/or an adjusted exposure time ET1 of the display 210, based on the first fingerprint image.

In an embodiment, an operation of determining, by the processor 240, an adjusted on/off period T0′ and/or an adjusted exposure time ET1 of the display 210, based on the first fingerprint image may be at least partially identical or similar to the operation, described with reference to FIG. 10, of determining an adjusted on/off period T0′ and/or an adjusted exposure time ET1 of the display 210, based on a first image (e.g., a dummy image), and thus redundant or duplicative description thereof may be omitted.

In an embodiment, the processor 240 may, based on an adjusted exposure time ET1 being determined based on the first fingerprint image, transfer the adjusted exposure time ET1 to the fingerprint sensor 220. For example, the processor 240 may compare an initial on/off period TO of the display 210 with the adjusted on/off period T0′ of the display 210. The processor 240 may transfer the adjusted exposure time ET1 to the fingerprint sensor 220, based on the initial on/off period TO of the display 210 not being equal to the adjusted on/off period T0′ of the display 210. For example, the processor 240 may compare the initial exposure time ET0 and the adjusted exposure time ET1 of the fingerprint sensor 220. The processor 240 may transfer the adjusted exposure time ET1 to the fingerprint sensor 220, based on the initial exposure time ET0 of the fingerprint sensor 220 not being equal to the adjusted exposure time ET1.

In an embodiment, when the initial on/off period TO of the display 210 is equal to the adjusted on/off period T0′ of the display 210, the initial exposure time ET0 and the adjusted exposure time ET1 of the fingerprint sensor 220 may also be the same. In this case, the processor 240 may not transfer the adjusted exposure time ET1 equal to the initial exposure time ET0 of the fingerprint sensor 220 to the fingerprint sensor 220, or may transfer, to the fingerprint sensor 220, information indicating that the initial exposure time ET0 and the adjusted exposure time ET1 of the fingerprint sensor 220 are the same (or the initial on/off period TO of the display 210 and the adjusted on/off period T0′ of the display 210 are the same).

At operation 1307, in an embodiment, the processor 240 may perform fingerprint authentication, based on the first fingerprint image.

In an embodiment, the processor 240 may perform the above pre-processing operation for the first fingerprint image and then perform an operation for extracting feature points from the first fingerprint image having been subjected to the pre-processing operation. The processor 240 may compare the first fingerprint image (e.g., the first fingerprint image having been subjected to an operation of extracting feature points) with registered fingerprint information, thereby determining whether fingerprint authentication is successful or fails.

In an embodiment, at least a part of operation 1305 and at least a part of operation 1307 may be performed in parallel or simultaneously.

In an embodiment, when the initial on/off period TO of the display 210 is equal to the adjusted on/off period T0′ of the display 210 and fingerprint authentication based on the first fingerprint image is successful, the processor 240 may perform an operation according to the success of the fingerprint authentication, and not perform operation 1309 and operation 1311 described below.

At operation 1309, in an embodiment, the processor 240 may obtain a second fingerprint image (e.g., a fingerprint image obtained subsequently to the first fingerprint image) using the fingerprint sensor 220 while the display 210 is emitting light set for acquisition of fingerprint information.

In an embodiment, the fingerprint sensor 220 may receive the adjusted exposure time ET1 from the processor 240. For example, the fingerprint sensor 220 may receive, from the processor 240, the adjusted exposure time ET1 obtained based on the adjusted on/off period T0′ of the display 210, based on the initial on/off period TO of the display 210 not being equal to the adjusted on/off period T0′ of the display 210.

In an embodiment, the fingerprint sensor 220 may obtain pixel values of the fingerprint sensor 220 by using the rolling shutter method, based on the adjusted exposure time ET1 while the display 210 is emitting light set for acquisition of fingerprint information. The fingerprint sensor 220 may transfer the obtained pixel values of the fingerprint sensor 220 to the processor 240.

In an embodiment, the processor 240 may obtain a second fingerprint image, based on the pixel values of the fingerprint sensor 220 received from the fingerprint sensor 220.

In an embodiment, when the initial on/off period TO of the display 210 is equal to the adjusted on/off period T0′ of the display 210, but fingerprint authentication fails at operation 1307, the processor 240 may obtain pixel values of the fingerprint sensor 220 by using the rolling shutter method, based on the initial exposure time ET0. The fingerprint sensor 220 may transfer the obtained pixel values of the fingerprint sensor 220 to the processor 240. The processor 240 may obtain a second fingerprint image, based on the pixel values of the fingerprint sensor 220 received from the fingerprint sensor 220.

At operation 1309, in an embodiment, the processor 240 may perform fingerprint authentication, based on the second fingerprint image.

An operation of performing fingerprint authentication, based on a second fingerprint image at operation 1309, may be at least partially identical or similar to an operation of performing fingerprint authentication, based on a first fingerprint image at operation 1307, and thus a detailed description may be omitted.

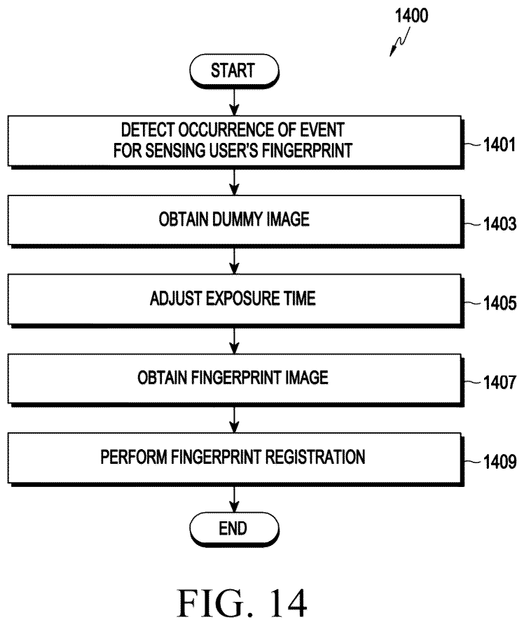

FIG. 14 is a flowchart 1400 illustrating a method of controlling the fingerprint sensor 220 according to an embodiment.

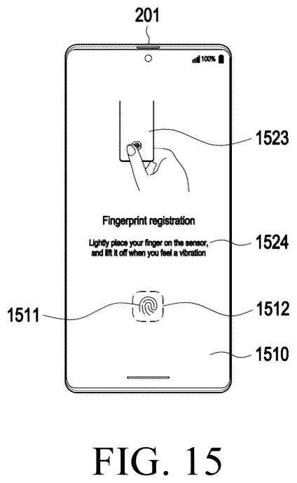

FIG. 15 is a diagram illustrating a method of controlling the fingerprint sensor 220 according to an embodiment.

In the embodiment described below, operations may be sequentially performed, but embodiments are not limited thereto. For example, the sequence of operations may be changed, and at least two operations may be performed in parallel.

According to an embodiment, it may be understood that operation 1401 through operation 1409 are performed by a processor (e.g., the processor 240 in FIG. 2) of an electronic device (e.g., the electronic device 201 in FIG. 2).

According to an embodiment, FIG. 14 and FIG. 15 may be diagrams illustrating an operation of determining an adjusted exposure time ET1 while registering a fingerprint.

At operation 1401, in an embodiment, the processor 240 may detect the occurrence of an event for sensing a fingerprint of a user.

In an embodiment, the processor 240 may obtain a touch input on the display 210. The processor 240 may detect the occurrence of an event for sensing a fingerprint of a user, based on a touch input on the display 210 being obtained.

According to an embodiment, in FIG. 15, the processor 240 may display a screen for fingerprint registration using the display 210. For example, the processor 240 may, based on an input for setting (e.g., registering) a fingerprint, display, using the display 210, a screen 1510 including an image 1523 and information 1524 that provides a guidance for fingerprint registration, together with a fingerprint icon 1511 displayed on a position of the display 210 corresponding to a position at which the fingerprint sensor 220 is disposed.

In an embodiment, the processor 240 may obtain a touch input using a touch sensor when a user touches an area 1512 including the fingerprint icon 1511 for fingerprint input by using a finger. The processor 240 may, when a touch input is obtained, perform an operation (e.g., operation 1403 through operation 1411) for fingerprint registration.

At operation 1403, in an embodiment, the processor 240 may, based on detection of the occurrence of an event for sensing a user's fingerprint, obtain a dummy image using the fingerprint sensor 220.

In an embodiment, the processor 240 may, based on a touch input (e.g., an event for sensing a user's fingerprint) on the display 210, provide, to the display 210, a first signal for allowing the display 210 to emit light set for acquisition of fingerprint information, and provide, to the fingerprint sensor 220, a fourth signal for obtaining an image (e.g., a dummy image) using the fingerprint sensor 220.

In an embodiment, an operation of providing, based on a touch input on the display 210, a first signal to the display 210 for allowing the display 210 to emit light set for acquisition of fingerprint information is described with reference to operation 703 in FIG. 7, and redundant or duplicative description thereof may be omitted.

In an embodiment, the fourth signal may include a command for activating the fingerprint sensor 220, a command for allowing the fingerprint sensor 220 to obtain pixel values of the fingerprint sensor 220 after the display 210 emits light set for acquisition of fingerprint information (or while the display is emitting the light), and/or an exposure time (e.g., an initial exposure time ET0 of the fingerprint sensor 220) stored in the memory 230.

In an embodiment, the processor 240 may obtain a dummy image using the fingerprint sensor 220 after the display 210 emits light set for acquisition of fingerprint information (or while the display is emitting the light).

In an embodiment, the fingerprint sensor 220 may, based on the fourth signal received from the processor 240, obtain pixel values of the fingerprint sensor 220 after the display 210 emits light set for acquisition of fingerprint information. For example, the fingerprint sensor 220 may, based on the fourth signal received from the processor 240, obtain pixel values of the fingerprint sensor 220 by using the rolling shutter method after the display 210 emits light set for acquisition of fingerprint information. The fingerprint sensor 220 may transfer the obtained pixel values of the fingerprint sensor 220 to the processor 240.

In an embodiment, the processor 240 may obtain a dummy fingerprint image, based on the pixel values of the fingerprint sensor 220 received from the fingerprint sensor 220.

At operation 1405, in an embodiment, the processor 240 may adjust an exposure time of the fingerprint sensor 220, based on the dummy image.

Operation 1405 may be at least partially identical or similar to operation 1305 in FIG. 13, and redundant or duplicative description thereof may be omitted.

At operation 1407, in an embodiment, the processor 240 may obtain a fingerprint image (e.g., an image obtained subsequently to the dummy image and used for acquisition of fingerprint information) using the fingerprint sensor 220 while the display 210 is emitting light set for acquisition of fingerprint information.

Operation 1407 may be at least partially identical or similar to operation 1309 in FIG. 13, and redundant or duplicative description thereof may be omitted.

In an embodiment, the processor 240 may obtain multiple second fingerprint images for fingerprint registration. For example, the processor 240 may obtain approximately five to fifteen fingerprint images for fingerprint registration, but embodiments are not limited thereto.

At operation 1409, in an embodiment, the processor 240 may perform fingerprint registration, based on a fingerprint image. For example, the processor 240 may perform an operation of performing a pre-processing operation and/or extracting feature points for a fingerprint image. The processor 240 may register the extracted feature points and/or the fingerprint image as the user's fingerprint information.

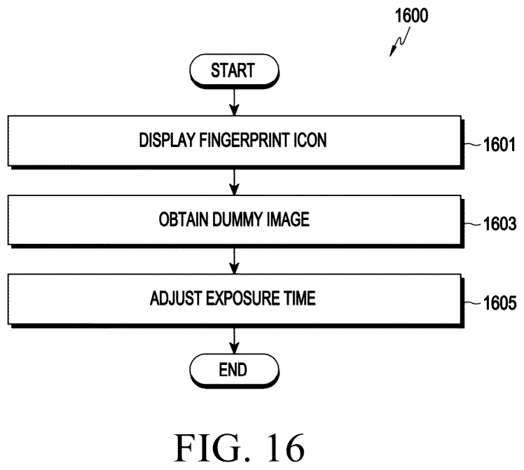

FIG. 16 is a flowchart 1600 illustrating a method of controlling the fingerprint sensor 220 according to an embodiment.

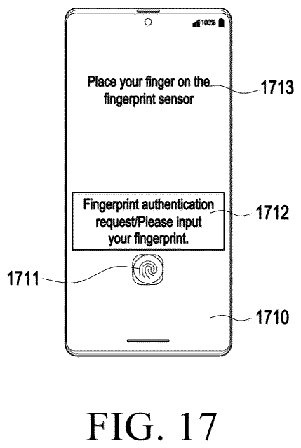

FIG. 17 is a diagram illustrating a method of controlling the fingerprint sensor 220 according to an embodiment.

In the embodiment described below, operations may be sequentially performed, but embodiments are not limited thereto. For example, the sequence of operations may be changed, and at least two operations may be performed in parallel.

According to an embodiment, it may be understood that operation 1601 through operation 1605 are performed by a processor (e.g., the processor 240 in FIG. 2) of an electronic device (e.g., the electronic device 201 in FIG. 2).

In an embodiment, in the above examples, an operation of determining an adjusted exposure time ET1, based on a touch input on the display 210 being obtained has been described, but the electronic device 201 may perform an operation of determining an adjusted exposure time ET1, based on a designated or predetermined condition (e.g., a condition of a designated or predetermined event occurring).

Referring to FIG. 16 and FIG. 17, at operation 1601, in an embodiment, the processor 240 may display a fingerprint icon using the display 210.

In an embodiment, the processor 240 may, while the electronic device 201 is in a locked state, display a fingerprint icon using the display 210, based on the display 210 of the electronic device 201 being turned on.

In an embodiment, the processor 240 may, while a payment application is running, display a fingerprint icon using the display 210 to perform a payment function. For example, as illustrated in FIG. 17, the processor 240 may display, using the display 210, a screen 1710 including a fingerprint icon 1711, information 1712 that guides a user to input a fingerprint for fingerprint authentication, and information 1713 that guides a user to put a finger on an area including the fingerprint icon 1711.

At operation 1603, in an embodiment, the processor 240 may obtain a dummy image, based on the fingerprint icon being displayed using the display 210.

In an embodiment, the processor 240 may, based on the fingerprint icon being displayed using the display 210, provide a fifth signal for obtaining a dummy image to the fingerprint sensor 220.

In an embodiment, the processor 240 may provide a fifth signal to the fingerprint sensor 220, based on the fingerprint icon being displayed using the display 210 for an area including the icon, regardless of a touch input for a fingerprint sensing area in the display 210 (e.g., before a touch input on the fingerprint sensing area in the display 210 is obtained).

In an embodiment, the fifth signal may include a command for activating the fingerprint sensor 220, a command for allowing the fingerprint sensor 220 to obtain pixel values of the fingerprint sensor 220 (e.g., pixel values of the fingerprint sensor 220 obtained for acquisition of a dummy image), and/or a designated or predetermined exposure time.

In an embodiment, the command for activating the fingerprint sensor 220 may be or may include a command for switching the light sensing area 310, the ADC 320, and the controller 330 included in the fingerprint sensor 220 from an inactive state (e.g., sleep state) to an active state (e.g., wakeup state) and supplying power to the light sensing area 310 and the ADC 320.

In an embodiment, the command for allowing the fingerprint sensor 220 to obtain pixel values of the fingerprint sensor 220 may be or may include a command for allowing the activated fingerprint sensor 220 to obtain pixel values of the fingerprint sensor 220, based on the rolling shutter method, so as to obtain a dummy image.

In an embodiment, the designated or predetermined exposure time included in the fifth signal may be a time obtained by multiplying an initial exposure time ET0 of the fingerprint sensor 220 by a predetermined integer (e.g., about ten (“10”)). For example, when a dummy image is obtained while the fingerprint icon is being displayed, it may be required to increase an exposure time for which the fingerprint sensor 220 obtains light, so that the fingerprint sensor 220 obtains a sufficient amount of light. Accordingly, the processor 240 may provide, to the fingerprint sensor 220, a fifth signal including an exposure time calculated by multiplying an initial exposure time ET0 of the fingerprint sensor 220 by a predetermined integer (e.g., about ten (“10”)). However, embodiments are not limited thereto. For example, the processor 240 may provide, to the fingerprint sensor 220, a fifth signal including the initial exposure time ET0 of the fingerprint sensor 220.

In an embodiment, the processor 240 may obtain a dummy image.

In an embodiment, the fingerprint sensor 220 may obtain pixel values of the fingerprint sensor 220 by using the rolling shutter method, based on a fifth signal received from the processor 240. For example, the fingerprint sensor 220 may be activated based on the fifth signal. The fingerprint sensor 220 may, after being activated, obtain pixel values of the fingerprint sensor 220 by using the rolling shutter method, based on an exposure time calculated by multiplying an initial exposure time ET0 of the fingerprint sensor 220 by a predetermined integer (e.g., about ten (“10”)). The fingerprint sensor 220 may transfer the obtained pixel values of the fingerprint sensor 220 to the processor 240.

In an embodiment, the processor 240 may generate a dummy image, based on the pixel values obtained from the fingerprint sensor 220.

At operation 1605, in an embodiment, the processor 240 may adjust an exposure time of the fingerprint sensor 220, based on the dummy image. An operation of determining the adjusted exposure time ET1, based on the dummy image at operation 1605 may be at least partially identical or similar to an operation of determining the adjusted exposure time ET1 through operations of FIG. 10. For example, the processor 240 may obtain an average pixel value for each row of the pixels of a dummy image. The processor 240 may identify an interval (e.g., a pattern interval) at which a first portion or a second portion appears repeatedly in the dummy image, based on the obtained average pixel value for each row of the pixels of the dummy image. The processor 240 may determine the number of pixels of the fingerprint sensor 220 corresponding to the obtained interval (e.g., the pattern interval) (e.g., the number of rows in each section in which the average pixel values of the rows of the pixels of the dummy image are repeated in the dummy image). The processor 240 may determine an adjusted exposure time ET1 of the fingerprint sensor 220, based on the number of pixels of the fingerprint sensor 220 corresponding to a pattern interval, a transfer time, and a designated or predetermined integer (n).

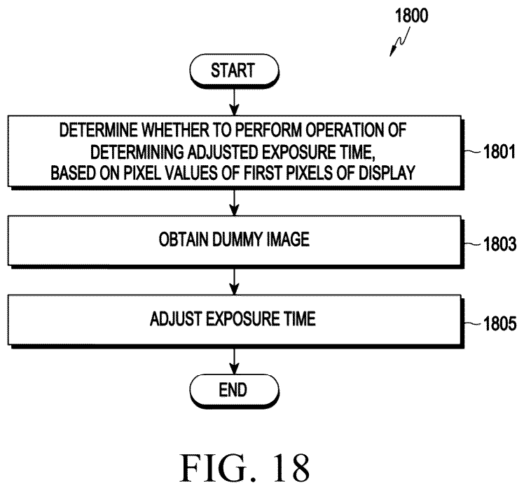

FIG. 18 is a flowchart 1800 illustrating a method of controlling the fingerprint sensor 220 according to an embodiment.

In the embodiment described below, operations may be sequentially performed, but embodiments are not limited thereto. For example, the sequence of operations may be changed, and at least two operations may be performed in parallel.

According to an embodiment, it may be understood that operation 1801 through operation 1805 are performed by a processor (e.g., the processor 240 in FIG. 2) of an electronic device (e.g., the electronic device 201 in FIG. 2).

In an embodiment, in FIG. 16, it is illustrated that an operation of determining the adjusted exposure time ET1 is performed based on a fingerprint icon being displayed, but embodiments are not limited thereto. For example, the electronic device 201 may perform an operation of determining the adjusted exposure time ET1 based on pixel values of first pixels of the display 210.

Referring to FIG. 18, at operation 1801, in an embodiment, the processor 240 may determine whether to perform an operation of determining the adjusted exposure time ET1, based on pixel values of first pixels of the display 210.

In an embodiment, as described above, the first pixels of the display 210 may include pixels, among all pixels of the display 210, set or selected to emit light having an intensity equal to or greater than a designated or predetermined intensity at the time of fingerprint authentication or fingerprint registration.

In an embodiment, the processor 240 may identify pixel values of the first pixels of the display 210 while a normal screen (e.g., a home screen) is being displayed.

In an embodiment, the processor 240 may determine to perform an operation of determining the adjusted exposure time ET1, based on the sum of the pixel values of the first pixels of the display 210 being equal to or greater than a threshold value. The processor 240 may determine not to perform an operation of determining the adjusted exposure time ET1, based on the sum of the pixel values of the first pixels of the display 210 being smaller than or less than the threshold value. In an embodiment, the sum of the pixel values of the first pixels of the display 210 may correspond to the sum of all intensities of light rays emitted by the first pixels of the display 210.

In an embodiment, the processor 240 may determine to perform an operation of determining the adjusted exposure time ET1, based on a ratio (which may be referred to as an “on pixel ratio”) being equal to or greater than a designated or predetermined ratio, the ratio being a ratio of the number of first pixels in an on state to the total number of the first pixels of the display 210. The processor 240 may determine not to perform an operation of determining the adjusted exposure time ET1, based on the ratio of the number of first pixels (e.g., among the first pixels) in an on state to the total number of the first pixels of the display 210 being smaller than the designated or predetermined ratio.

At operation 1803, in an embodiment, the processor 240 may obtain a dummy image, based on determination to perform an operation of determining the adjusted exposure time ET1.

In an embodiment, the processor 240 may, based on determination to perform an operation of determining the adjusted exposure time ET1, provide a sixth signal for obtaining a dummy image to the fingerprint sensor 220.

In an embodiment, the sixth signal may include a command for activating the fingerprint sensor 220, a command for allowing the fingerprint sensor 220 to obtain pixel values of the fingerprint sensor 220 (e.g., pixel values of the fingerprint sensor 220 obtained for acquisition of a dummy image), and/or a designated or predetermined exposure time.

In an embodiment, the command for activating the fingerprint sensor 220 may be or may include a command for switching the light sensing area 310, the ADC 320, and the controller 330 included in the fingerprint sensor 220 from an inactive state (e.g., sleep state) to an active state (e.g., wakeup state) and supplying power to the light sensing area 310 and the ADC 320.

In an embodiment, the command for allowing the fingerprint sensor 220 to obtain pixel values of the fingerprint sensor 220 may be or may include a command for allowing the activated fingerprint sensor 220 to obtain pixel values of the fingerprint sensor 220, based on the rolling shutter method, so as to obtain a dummy image.

In an embodiment, the designated or predetermined exposure time included in the sixth signal may be a time obtained by multiplying an initial exposure time ET0 of the fingerprint sensor 220 by a predetermined integer (e.g., about ten (“10”)). For example, when a dummy image is obtained while a normal screen is being displayed, it may be required to increase an exposure time for which the fingerprint sensor 220 obtains light, so that the fingerprint sensor 220 obtains a sufficient amount of light. Accordingly, the processor 240 may provide, to the fingerprint sensor 220, a sixth signal including an exposure time calculated by multiplying an initial exposure time ET0 of the fingerprint sensor 220 by a predetermined integer (e.g., about ten (“10”)). However, embodiments are not limited thereto. For example, the processor 240 may provide, to the fingerprint sensor 220, a sixth signal including the initial exposure time ET0 of the fingerprint sensor 220.

In an embodiment, the processor 240 may obtain a dummy image.

In an embodiment, the fingerprint sensor 220 may obtain pixel values of the fingerprint sensor 220 using the rolling shutter method, based on the sixth signal received from the processor 240. For example, the fingerprint sensor 220 may be activated based on the sixth signal. The fingerprint sensor 220 may, after being activated, obtain pixel values of the fingerprint sensor 220 using the rolling shutter method, based on an exposure time calculated by multiplying an initial exposure time ET0 of the fingerprint sensor 220 by a predetermined integer (e.g., about ten (“10”)). The fingerprint sensor 220 may transfer the obtained pixel values of the fingerprint sensor 220 to the processor 240.

In an embodiment, the processor 240 may generate a dummy image, based on the pixel values obtained from the fingerprint sensor 220.

At operation 1805, in an embodiment, the processor 240 may adjust an exposure time of the fingerprint sensor 220, based on the dummy image.

An operation of adjusting an exposure time ET1, based on a dummy image at operation 1805 may be at least partially identical or similar to an operation of adjusting an exposure time through operations of FIG. 10. For example, the processor 240 may obtain an average pixel value for each row of the pixels of a dummy image. The processor 240 may identify an interval (e.g., a pattern interval) at which a first portion or a second portion appears repeatedly in the dummy image, based on the obtained average pixel value for each row of the pixels of the dummy image. The processor 240 may determine the number of pixels of the fingerprint sensor 220 corresponding to the obtained interval (e.g., the pattern interval) (e.g., the number of rows in each section in which the average pixel values of the rows of the pixels of the dummy image are repeated in the dummy image). The processor 240 may determine an adjusted exposure time ET1 of the fingerprint sensor 220, based on the number of pixels of the fingerprint sensor 220 corresponding to a pattern interval, a transfer time, and a designated or predetermined integer (n).

In an embodiment, in FIG. 18, an operation of determining the adjusted exposure time ET1 is illustrated as being performed based on pixel values of first pixels of the display 210, but embodiments are not limited thereto. For example, the processor 240 may perform operations (e.g., operation 1803 through operation 1805) including an operation of determining the adjusted exposure time ET1 every set time (e.g., every about 1 hour). For example, the processor 240 may measure the temperature of the electronic device 201. The processor 240 may perform operations (e.g., operation 1803 through operation 1807) including an operation of determining the adjusted exposure time ET1, based on the variance of the temperature of the electronic device 201 being equal to or greater than a threshold variance, when the temperature of the electronic device 201 is equal to or greater than a first threshold temperature or is equal to or smaller than a second threshold temperature (where the second threshold temperature lower than the first threshold temperature).

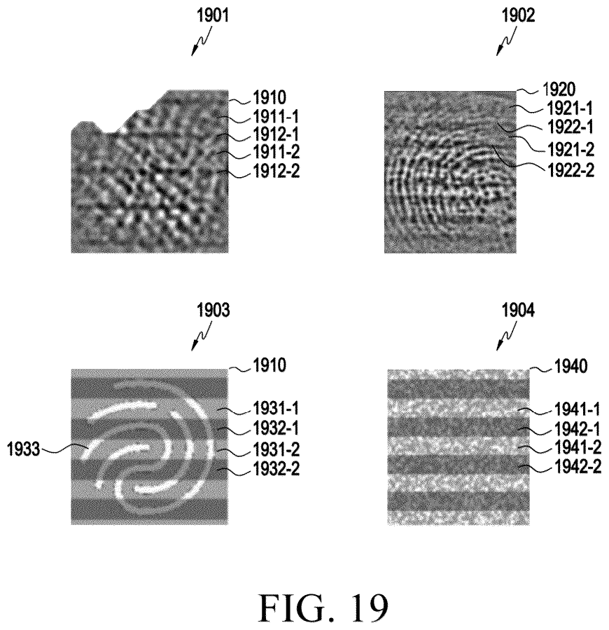

FIG. 19 is a diagram illustrating images including a pattern caused by flicker noise according to an embodiment.

Referring to FIG. 19, in an embodiment, as shown in example 1901, an image 1910 may be a first image (e.g., dummy image) obtained through operation 703 in FIG. 7. As shown in example 1901, the image 1910 may include a design appearing due to a fingerprint (and fingerprint icon) and first portions 1911-1 and 1911-2 and second portions 1912-1 and 1912-2 appearing alternatingly and repeatedly due to flicker noise.

In an embodiment, as shown in example 1902, an image 1920 may be a first fingerprint image obtained through operation 1405 in FIG. 14. For example, the image 1920 may include a design appearing due to a fingerprint (and fingerprint icon) and first portions 1921-1 and 1921-2 and second portions 1922-1 and 1922-2 appearing alternatingly and repeatedly due to flicker noise.

In an embodiment, as shown in example 1903, an image 1930 may be a dummy image obtained through operation 1605 in FIG. 16. For example, the image 1930 may include a design 1933 appearing due to a fingerprint icon and first portions 1931-1 and 1931-2 and second portions 1932-1 and 1932-2 appearing alternatingly and repeatedly due to flicker noise.

In an embodiment, as shown in example 1904, an image 1940 may be a dummy image obtained through operation 1805 in FIG. 18. For example, the image 1924 may include first portions 1941-1 and 1941-2 and second portions 1942-1 and 1942-2 appearing alternatingly and repeatedly due to flicker noise.

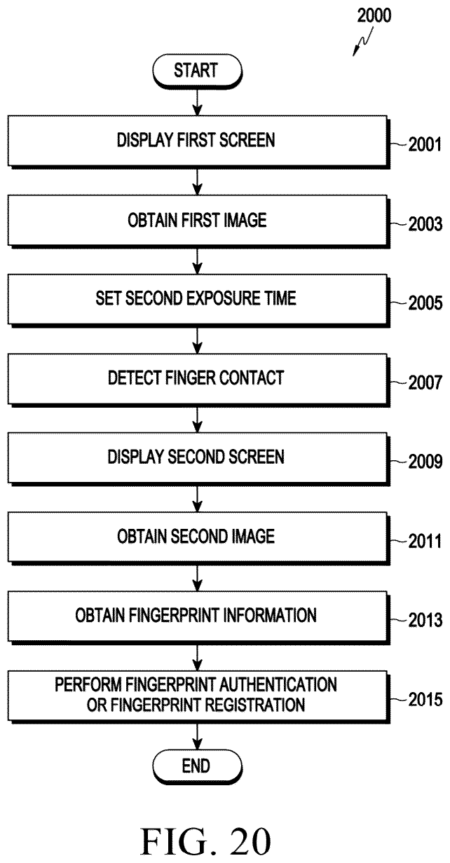

FIG. 20 is a flowchart 2000 illustrating a method of controlling the fingerprint sensor 220 according to an embodiment.

In the embodiment described below, operations may be sequentially performed, but embodiments are not limited thereto. For example, the sequence of operations may be changed, and at least two operations may be performed in parallel.

According to an embodiment, it may be understood that operation 2003 through operation 2015 are performed by a processor (e.g., the processor 240 in FIG. 2) of the electronic device 201 (e.g., the electronic device 201 in FIG. 2).

Referring to FIG. 20, at operation 2001, in an embodiment, the processor 240 may display a first screen using the display 210.

In an embodiment, the processor 240 may display the first screen using the display 210, based at least partially on reception of a fingerprint input request.

In an embodiment, the first screen may be a fingerprint input guide screen. For example, the first screen may be a screen (e.g., the screen 810, the screen 1510, or the screen 1710) including a fingerprint icon (e.g., the fingerprint icon 811, the fingerprint icon 1511, or the fingerprint icon 1711).

In an embodiment, the fingerprint input request may include an event (or input) allowing or causing a fingerprint input guide screen to be displayed. For example, the fingerprint input request may be an event showing that the display 210 is switched from the off state to the on state, when a fingerprint input guide screen including a fingerprint icon is displayed using the display 210 in a locked state of the electronic device 201 according to switching of the display 210 from the off state to the on state. For example, the fingerprint input request may be an event showing that a payment function is executed, when the payment function is performed using a fingerprint while a payment application is running.

At operation 2003, in an embodiment, the processor 240 may obtain a first image using the fingerprint sensor 220 according to a first exposure time set for the fingerprint sensor 220, during at least a part of a time for which the first screen is displayed.

In an embodiment, the first exposure time may be an exposure time (e.g., initial exposure time ET0) obtained by multiplying, by a designated or predetermined integer (n), an initial on/off period of the display 210 (which may also be referred to as “an on/off period set as a default of the display 210”) described above.

In an embodiment, the processor 240 may obtain a dummy image described above as the first image using the fingerprint sensor 220 according to the first exposure time during at least a part of a time for which the first screen is displayed. An example of obtaining the first image using the fingerprint sensor 220 according to the first exposure time is described above, and redundant or duplicative description thereof may be omitted.

In an embodiment, the first exposure time may be set based at least partially on refresh rate information of the display 210. For example, the processor 240 may calculate an exposure time by multiplying, by a designated or predetermined integer, an initial on/off period of the display 210 corresponding to the refresh rate of the display 210 (e.g., a refresh rate currently set for the display 210). The processor 240 may set the calculated exposure time as the first exposure time.

In an embodiment, the processor 240 may use another sensor configured to detect external environment information about the electronic device 201, so as to detect the external environment information by using the other sensor. The processor 240 may perform an operation of obtaining the first image, based at least partially on the external environment information satisfying a designated or predetermined condition.

In an embodiment, the external environment information of the electronic device 201 may include external environment information that may change an actual refresh rate of the display 210. For example, the external environment information may include the temperature of the electronic device 201, the ambient brightness of the electronic device 201, and/or the brightness of the display 210 of the electronic device 201, which may change a clock generated by an oscillator.

In an embodiment, the sensor configured to detect the external environment information about the electronic device 201 may include a temperature sensor (e.g., a temperature sensor included in the fingerprint sensor 220 or a system) capable of detecting the temperature of the electronic device 201, and an illuminance sensor capable of detecting the ambient brightness of the electronic device 201 and/or the brightness of the display 210. However, the sensor configured to detect the external environment information about the electronic device 201 is not limited to the above examples.

In an embodiment, the processor 240 may perform an operation of obtaining a first image, based on the external environment information satisfying a designated or predetermined condition.

In an embodiment, if the temperature of the electronic device 201 is lower than about-5 degrees Celsius (e.g., about 30 degrees Celsius lower than a room temperature of about 25 degrees Celsius) or is higher than about 60 degrees Celsius (e.g., about 35 degrees Celsius higher than a room temperature of about 25 degrees Celsius), this may affect the refresh rate change of the display 210. In an embodiment, the processor 240 may obtain the temperature of the electronic device 201 by using the temperature sensor. If the temperature of the electronic device 201 is equal to or higher than about-5 degrees Celsius and is equal to or lower than about 60 degrees Celsius, the processor 240 may determine that the external environment information does not satisfy the designated or predetermined condition. If the temperature of the electronic device 201 is lower than about-5 degrees Celsius or exceeds about 60 degrees Celsius, the processor 240 may determine that the external environment information satisfies the designated or predetermined condition. In the above example, obtaining a first image, based on the temperature of the electronic device 201 satisfying a designated or predetermined condition has been illustrated, but embodiments are not limited thereto. For example, if the ambient brightness of the electronic device 201 and/or the brightness of the display 210 belongs to a designated or predetermined range, the processor 240 may determine that the designated or predetermined condition is not satisfied. If the ambient brightness of the electronic device 201 and/or the brightness of the display 210 does not belong to the designated or predetermined range, the processor 240 may determine that the designated or predetermined condition is satisfied.

In an embodiment, the processor 240 may not perform an operation of obtaining a first image (and an operation of setting a second exposure time described below), based on the external environment information satisfying the designated or predetermined condition.

In an embodiment, the processor 240 may display, using the display 210, an indicator indicating that an operation of obtaining a first image is to be performed, based at least partially on the designated or predetermined condition being satisfied.

In an embodiment, the processor 240 may display, using the display 210, a user interface (e.g., icon) for receiving a user input for executing an operation of obtaining a first image, based at least partially on the external environment information satisfying the designated or predetermined condition.

In an embodiment, the processor 240 may monitor a user's finger contact on the display 210 while displaying the first screen. The processor 240 may obtain a first image, based on the contact being detected.

At operation 2005, in an embodiment, the processor 240 may set a second exposure time for the fingerprint sensor 220 instead of the first exposure time, based at least partially on the first image.

In an embodiment, the second exposure time may be an adjusted exposure time ET1 of the fingerprint sensor 220 described above.

In an embodiment, an example of adjusting an exposure time for the fingerprint sensor 220 from a first exposure time to a second exposure time, based on at least partially on a first image, is described above, and redundant or duplicative description thereof may be omitted.

In an embodiment, the processor 240 may determine changed refresh information of the display 210, based on the first image (e.g., dummy image). For example, the processor 240 may determine a changed refresh rate of the display 210 corresponding to an adjusted on/off period T0′ of the display 210 described above. The processor 240 may determine a second exposure time, based on the changed refresh rate of the display 210 (or the adjusted on/off period T0′ of the display 210).

At operation 2007, in an embodiment, the processor 240 may detect a user's finger contact.

In an embodiment, the processor 240 may detect a touch input made using a user's finger on an area including a fingerprint icon (e.g., the area 1512 including the fingerprint icon 1511) using the display 210 while a first screen (e.g., fingerprint input guide screen) including the fingerprint icon is being displayed.

At operation 2009, in an embodiment, the processor 240 may display a second screen using the display 210 in response to a finger contact being detected.

In an embodiment, the processor 240 may, in response to a finger contact being detected (e.g., a touch input on the area including the fingerprint icon), emit light emitted at a predetermined intensity for sensing a fingerprint (e.g., light having an intensity equal to or greater than a designated or predetermined intensity) using the display 210. The processor 240 may display a second screen, using the display 210, represented by emission of the light emitted at a predetermined intensity for sensing a fingerprint. For example, the processor 240 may control the display 210 to display, as the second screen, a white image at a maximum luminance of the display 210 (e.g., a circular white image displayed at the maximum luminance).

In an embodiment, a fingerprint sensing area substantially arranged on the fingerprint sensor 220 may be included.

In an embodiment, the processor 240 may perform an operation of displaying the second screen so that the fingerprint sensing area is displayed to have a brightness greater than that of an area corresponding to the first screen.

In an embodiment, the processor 240 may display a first guide image and a second guide image that differ by at least one attribute (e.g., size, shape, and/or brightness), using the display 210 on the corresponding area of the first screen (e.g., the fingerprint input guide screen) and the fingerprint sensing area, respectively. For example, if a first guide image is displayed on the corresponding area of the first screen, the processor 240 may, when displaying the second screen, control the display 210 such that a second guide image having an attribute different from an attribute of the first guide image is displayed on the fingerprint sensing area. A first guide image and a second guide image are displayed such that the attribute of the first guide image differs from the attribute of the second guide image, whereby, when a first image is obtained, a user is able to recognize that the image obtained using the fingerprint sensor 220 is a dummy image rather than an image used for authentication or registration.

At operation 2011, in an embodiment, the processor 240 may obtain a second image corresponding to the finger using the fingerprint sensor 220 according to the second exposure time during at least a part of a time for which the second screen is displayed.

At operation 2013, in an embodiment, the processor 240 may obtain fingerprint information corresponding to the finger, based at least partially on the second image.

At operation 2015, in an embodiment, the processor 240 may perform fingerprint authentication or fingerprint registration for the user, based on the fingerprint information.

Operation 2011, operation 2013, and operation 2015 may be similar to operation 709 of FIG. 7 and operation 1407 and operation 1409 of FIG. 14, and redundant or duplicative description thereof may be omitted.

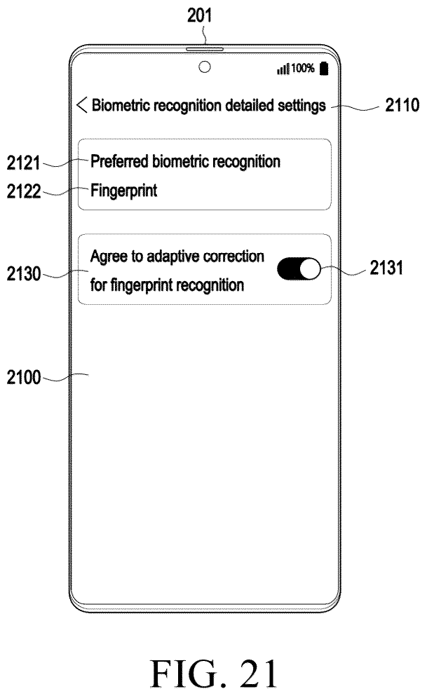

FIG. 21 is a diagram illustrating a method of controlling the fingerprint sensor 220 according to an embodiment.

Referring to FIG. 21, in an embodiment, the processor 240 may set a mode (which may be referred to as a “first mode” or “improved authentication mode”) capable of adaptively adjusting an exposure time.

In an embodiment, the first mode may be a mode using an image (e.g., dummy image) obtained using the fingerprint sensor 220 to adjust the exposure time of the fingerprint sensor 220 and obtain fingerprint information by using the adjusted exposure time.

In an embodiment, the processor 240 may allow the electronic device 201 to operate in the first mode when the first mode is set, at the time of fingerprint authentication, at the time of fingerprint registration, or when a designated or predetermined event occurs.

In an embodiment, when the first mode is set, the processor 240 may allow electronic device 201 to operate in the first mode if external environment information satisfies a designated or predetermined condition (e.g., the temperature of the electronic device 201 is lower than about-5 degrees or exceeds about 60 degrees as a designated or predetermined temperature range). For example, when the first mode is set, if the temperature of the electronic device 201 satisfies a designated or predetermined temperature range, the processor 240 may adjust the exposure time of the fingerprint sensor 220 from a first exposure time to a second exposure time for one time only.

In an embodiment, a second mode (which may also be referred to as a “normal mode”) may be a mode in which a first exposure time may be used to obtain fingerprint information without adjusting the exposure time of the fingerprint sensor 220 from the first exposure time to a second exposure time.

In an embodiment, the processor 240 may set the first mode using a setting menu. For example, screen 2100 of FIG. 21 may be a screen including a setting menu. The screen 2100 may include a text 2110 representing detailed settings of biometric recognition, a text 2121 and a text 2122 representing the type of authentication subject to setting, a text 2130 guiding turning on (e.g., activation) or off (e.g., deactivation) of the first mode, and an object 2131 (e.g., an icon) for turning on or off the first mode. The processor 240 may selectively turn on or turn off the first mode, based on a user input on the object 2131.

In an embodiment, although not illustrated in FIG. 21, the screen 2100 may include a guide indicating that the electronic device 201 may operate in the first mode or the second mode according to the temperature of the electronic device 201.

In FIG. 21, a method of setting the first mode through a setting menu is illustrated, but embodiments are not limited thereto. For example, the processor 240 may obtain the temperature of the electronic device 201 by using a temperature sensor (e.g., a temperature sensor included in the fingerprint sensor 220 or a system). The processor 240 may, when the obtained temperature of the electronic device 201 belongs to a designated or predetermined range, display a menu (e.g., a window including the text 2130 and the object 2131) enabling the first mode to be set (e.g., the first mode to be turned on or off) using the display 210 in a pop-up form. The processor 240 may set the first mode (e.g., turn on or off the first mode), based on a user input (e.g., a user input on a menu displayed in a pop-up form).

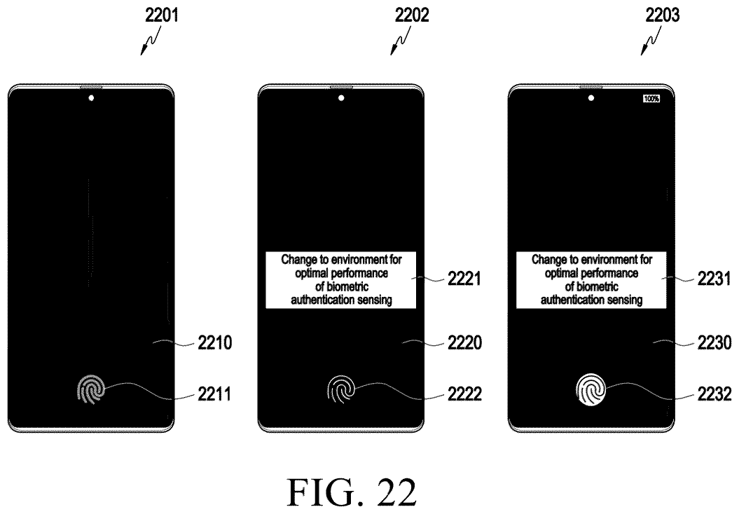

FIG. 22 is a diagram illustrating a method of controlling the fingerprint sensor 220 according to an embodiment.

Referring to FIG. 22, in an embodiment, the processor 240 may display, using the display 210, fingerprint icons having different attributes in the first mode and the second mode.

In an embodiment, as shown in example 2201 in FIG. 22, in the second mode (normal mode) (or when the temperature of the electronic device 201 does not belong to a designated or predetermined temperature range in the first mode), the processor 240 may display a screen 2210 including a first fingerprint icon 2211 using the display 210.

As shown in example 2202, after the first mode is set, when the temperature of the electronic device 201 belongs to a designated or predetermined temperature range, the processor 240 may display, using the display 210, a screen 2220 including a second fingerprint icon 2222 having a brightness higher than that of the first fingerprint icon 2211, together with information 2221 indicating that an environment in which fingerprint authentication is performed is changed to an environment in which fingerprint information is obtained, through an operation of adaptively setting an exposure time of the fingerprint sensor 220. However, embodiments are not limited thereto. For example, as shown in example 2203, after the first mode is set, when the temperature of the electronic device 201 belongs to a designated or predetermined temperature range, the processor 240 may display, using the display 210, a screen 2230 including an area 2232 having a brightness higher than a brightness of an area including the first fingerprint icon 2211, together with information 2231 identical to the information 2221. In the above example, changing the brightness of a fingerprint icon (or an area including the fingerprint icon) has been described, but embodiments are not limited thereto, and the size and shape of the fingerprint icon (or an area including the fingerprint icon) may be changed.

In an embodiment, when the temperature of the electronic device 201 belongs to a designated or predetermined temperature range, the processor 240 may obtain a first image (e.g., dummy image) using the fingerprint sensor 220. The processor 240 may calculate an offset of an on/off period of the display 210, based on the first image. The processor 240 may match the temperature of the electronic device 201 with the calculated offset and then store same in the memory 230. The processor 240 may store the temperature of the electronic device 201 and the offset corresponding to the temperature of the electronic device 201 in the memory 230 and then perform fingerprint authentication or fingerprint registration. The processor 240 may obtain the temperature of the electronic device 201 using a temperature sensor at the time of fingerprint authentication or fingerprint registration. The processor 240 may obtain an offset corresponding to the obtained temperature of the electronic device 201 from the memory 230. The processor 240 may adjust an exposure time of the fingerprint sensor 220, based on the obtained offset.

An electronic device according to an embodiment may include a display, a fingerprint sensor disposed under the display and set or selected to obtain an image by sensing light, one or more memories storing processor-executable instructions, and one or more processors including electronic circuitry. The one or more processors may be individually or collectively operable to execute the instructions stored on the one or more memories to cause the electronic device to detect an occurrence of an event for sensing a fingerprint of a user. The one or more processors may be individually or collectively operable to execute the instructions to cause the electronic device to, in response to or based on detecting the occurrence of the event for sensing the fingerprint of the user, obtain a first image using the fingerprint sensor before the display emits light at a predetermined intensity for sensing a fingerprint. The one or more processors may be individually or collectively operable to execute the instructions to cause the electronic device to analyze at least one pattern corresponding to a flicker noise in the first image. The one or more processors may be individually or collectively operable to execute the instructions to cause the electronic device to, based on the analysis, adjust at least one exposure time of the fingerprint sensor for sensing light, emitted by the display at the predetermined intensity and reflected by the fingerprint of the user. The one or more processors may be individually or collectively operable to execute the instructions stored on the one or more memories to cause the electronic device to, based on the adjusted at least one exposure time, obtain a second image by using the fingerprint sensor by sensing light, emitted by the display at the predetermined intensity and reflected by the fingerprint of the user.

In an embodiment, the one or more processors may be individually or collectively operable to execute the instructions to cause the electronic device to, in response to detecting the occurrence of the event for sensing the fingerprint of the user, before the display emits light at the predetermined intensity for sensing the fingerprint, provide, to the display, a signal for emitting, by the display, light at the predetermined intensity for sensing the fingerprint, and provide, to the fingerprint sensor, a signal for obtaining the first image using the fingerprint sensor. The one or more processors may be individually or collectively operable to execute the instructions to cause the electronic device to, in response to detecting the occurrence of the event for sensing the fingerprint of the user, before the display emits light at the predetermined intensity for sensing the fingerprint, obtain the first image, based on pixel values being obtained sequentially in units of rows of pixels of the fingerprint sensor.

In an embodiment, the signal for obtaining the first image may include a command for activating the fingerprint sensor, a command for obtaining, by the fingerprint sensor, pixel values of the fingerprint sensor used to obtain the first image, a command for obtaining, by the fingerprint sensor, pixel values used to obtain the second image after emitting, by the display, light at the predetermined intensity for sensing the fingerprint, and the at least one exposure time stored in the memory.

In an embodiment, the at least one pattern may include plurality of first portions and plurality of second portions darker than the plurality of first portions, wherein the plurality of first portions and the plurality of second portions appear alternatingly and repeatedly in the first image. The one or more processors may be individually or collectively operable to execute the instructions to cause the electronic device to, by obtaining an average value of pixel values of pixels included in a row for each of rows of pixels of the first image, obtain average pixel values respectively corresponding to the rows of the pixels of the first image. The one or more processors may be individually or collectively operable to execute the instructions to cause the electronic device to identify an interval at which the plurality of first portions or the plurality of second portions is repeatedly appear in the first image. The one or more processors may be individually or collectively operable to execute the instructions to cause the electronic device to determine a number of rows of pixels of the fingerprint sensor 220 corresponding to the interval. The one or more processors may be individually or collectively operable to execute the instructions to cause the electronic device to, based on the determined number, adjust the at least one exposure time.

In an embodiment, the one or more processors may be individually or collectively operable to execute the instructions to cause the electronic device to detect the occurrence of the event for sensing the fingerprint of the user while displaying a screen for registering a fingerprint using the display. The one or more processors may be individually or collectively operable to execute the instructions to cause the electronic device to, in response to detecting the occurrence of the event for sensing the fingerprint of the user, obtain a third image by using the fingerprint sensor while the display emits light at the predetermined intensity for sensing the fingerprint. The one or more processors may be individually or collectively operable to execute the instructions to cause the electronic device to analyze at least one pattern corresponding to the flicker noise in the third image. The one or more processors may be individually or collectively operable to execute the instructions to cause the electronic device to, based on the analysis, adjust at least one exposure time of the fingerprint sensor for sensing light, emitted by the display at the predetermined intensity and reflected by the fingerprint of the user. The one or more processors may be individually or collectively operable to execute the instructions to cause the electronic device to, based on the adjusted at least one exposure time, obtain one or more fingerprint images by using the fingerprint sensor by sensing light, emitted by the display at the predetermined intensity and reflected by the fingerprint of the user.

In an embodiment, the one or more processors may be individually or collectively operable to execute the instructions to cause the electronic device to, based on displaying a fingerprint icon using the display, obtain a fourth image by using the fingerprint sensor. The one or more processors may be individually or collectively operable to execute the instructions to cause the electronic device to analyze at least one pattern corresponding to the flicker noise in the fourth image. The one or more processors may be individually or collectively operable to execute the instructions to cause the electronic device to, based on the analysis, adjust the at least one exposure time of the fingerprint sensor for sensing light, emitted by the display at the predetermined intensity and reflected by the fingerprint of the user.

In an embodiment, the one or more processors may be individually or collectively operable to execute the instructions to cause the electronic device to obtain a fifth image, based on a ratio of first pixels in an on state to first pixels of the display arranged in a region corresponding to a location of the fingerprint sensor being equal to or greater than a designated or predetermined ratio. The one or more processors may be individually or collectively operable to execute the instructions to cause the electronic device to analyze at least one pattern corresponding to the flicker noise in the fifth image. The one or more processors may be individually or collectively operable to execute the instructions to cause the electronic device to, based on the analysis, adjust the at least one exposure time of the fingerprint sensor for sensing light, emitted by the display at the predetermined intensity and reflected by the fingerprint of the user.

In an embodiment, a method of controlling a fingerprint sensor in an electronic device may include detecting an occurrence of an event for sensing a fingerprint of a user. The method may include, in response to detecting the occurrence of the event for sensing the fingerprint of the user, obtaining a first image by using the fingerprint sensor before the display emits light at a predetermined intensity for sensing a fingerprint. The method may include analyzing at least one pattern corresponding to a flicker noise in the first image. The method may include, based on the analysis, adjusting at least one exposure time of the fingerprint sensor for sensing light, emitted by the display at the predetermined intensity and reflected by the fingerprint of the user. The method may include, based on the adjusted at least one exposure time, obtaining a second image by using the fingerprint sensor by sensing light, emitted by the display at the predetermined intensity and reflected by the fingerprint of the user.

In an embodiment, the obtaining of the first image by using the fingerprint sensor may include, in response to detecting the occurrence of the event for sensing the fingerprint of the user, before the display emits light at the predetermined intensity for sensing the fingerprint, providing, to the display, a signal for emitting, by the display, light at the predetermined intensity for sensing the fingerprint, and providing, to the fingerprint sensor, a signal for obtaining the first image using the fingerprint sensor. The obtaining of the first image by using the fingerprint sensor may include, in response to detecting the occurrence of the event for sensing the fingerprint of the user, before the display emits light at the predetermined intensity for sensing the fingerprint, obtaining the first image, based on pixel values being obtained sequentially in units of rows of pixels of the fingerprint sensor.

In an embodiment, the signal for obtaining the first image may include a command for activating the fingerprint sensor, a command for obtaining, by the fingerprint sensor, pixel values of the fingerprint sensor used to obtain the first image, a command for obtaining, by the fingerprint sensor, pixel values used to obtain the second image after emitting, by the display, light at the predetermined intensity for sensing the fingerprint, and the at least one exposure time stored in memory of the electronic device.

In an embodiment, the at least one pattern may include a plurality of first portions and a plurality of second portions darker than the plurality of first portions, wherein the plurality of first portions and the plurality of second portions appear alternatingly and repeatedly in the first image. The analyzing of the at least one pattern may include, by obtaining an average value of pixel values of pixels included in a row for each of rows of pixels of the first image, obtaining average pixel values respectively corresponding to the rows of the pixels of the first image. The analyzing of the at least one pattern may include identifying an interval at which the plurality of first portions or the plurality of second portions repeatedly appear in the first image. The analyzing of the at least one pattern may include determining a number of rows of pixels of the fingerprint sensor 220 corresponding to the interval. The adjusting of the at least one exposure time of the fingerprint sensor may include adjusting the at least one exposure time, based on the determined number.

In an embodiment, the method may further include detecting the occurrence of the event for sensing the fingerprint of the user while displaying a screen for registering a fingerprint using the display. The method may further include, in response to detecting the occurrence of the event for sensing the fingerprint of the user, obtaining a third image by using the fingerprint sensor while the display emits light at the predetermined intensity for sensing the fingerprint. The method may further include analyzing at least one pattern corresponding to the flicker noise in the third image. The method may further include, based on the analysis, adjusting at least one exposure time of the fingerprint sensor for sensing light, emitted by the display at the predetermined intensity and reflected by the fingerprint of the user. The method may further include, based on the adjusted at least one exposure time, obtaining one or more fingerprint images by using the fingerprint sensor by sensing light, emitted by the display at the predetermined intensity and reflected by the fingerprint of the user.

In an embodiment, the method may further include, based on displaying a fingerprint icon using the display, obtaining a fourth image by using the fingerprint sensor. The method may further include analyzing at least one pattern corresponding to the flicker noise in the fourth image. The method may further include, based on the analysis, adjusting the at least one exposure time of the fingerprint sensor for sensing light, emitted by the display at the predetermined intensity and reflected by the fingerprint of the user.

In an embodiment, an electronic device 201 may include a display 210, a fingerprint sensor 220 disposed under the display 210 and configured to obtain an image by sensing light, one or more memories storing processor-executable instructions, and one or more processors including electronic circuitry. The one or more processors may be individually or collectively operable to execute the instructions to cause the electronic device to display a first screen via the display. The one or more processors may be individually or collectively operable to execute the instructions to cause the electronic device to, during at least a part of a time for which the first screen is displayed, obtain a first image through the fingerprint sensor according to a first exposure time set for the fingerprint sensor. The one or more processors may be individually or collectively operable to execute the instructions to cause the electronic device to, based at least partially on the first image, set a second exposure time for the fingerprint sensor instead of the first exposure time. The one or more processors may be individually or collectively operable to execute the instructions to cause the electronic device to detect contact by a user's finger. The one or more processors may be individually or collectively operable to execute the instructions to cause the electronic device to, in response to the contact by the finger being detected, display a second screen via the display. The one or more processors may be individually or collectively operable to execute the instructions to cause the electronic device to, during at least a part of a time for which the second screen is displayed, obtain a second image corresponding to the finger using the fingerprint sensor according to the second exposure time. The one or more processors may be individually or collectively operable to execute the instructions to cause the electronic device to, based at least partially on the second image, obtain fingerprint information corresponding to the finger. The one or more processors may be individually or collectively operable to execute the instructions to cause the electronic device to, based at least partially on the fingerprint information, perform fingerprint authentication or fingerprint registration for the user.

In an embodiment, the first exposure time may be set based at least partially on refresh rate information of the display. The one or more processors may be individually or collectively operable to execute the instructions to cause the electronic device to determine changed refresh rate information of the display 210, based on the first image. The one or more processors may be individually or collectively operable to execute the instructions to cause the electronic device to determine the second exposure time, based at least partially on the changed refresh rate information.

In an embodiment, the electronic device may further include a sensor configured to detect external environment information about the electronic device. The one or more processors may be individually or collectively operable to execute the instructions to cause the electronic device to detect the external environment information by using the sensor. In an embodiment, the one or more processors may be individually or collectively operable to execute the instructions to cause the electronic device to, based at least partially on the external environment information satisfying a designated or predetermined condition, perform an operation of obtaining the first image.

In an embodiment, the one or more processors may be individually or collectively operable to execute the instructions to cause the electronic device to, based at least partially on the external environment information satisfying the designated or predetermined condition, display, using the display, an indicator indicating that an operation of obtaining the first image is to be performed.

In an embodiment, the one or more processors may be individually or collectively operable to execute the instructions to cause the electronic device to, based at least partially on the external environment information satisfying the designated or predetermined condition, display, using the display, a user interface for receiving a user input for executing an operation of obtaining the first image.

In an embodiment, the second screen may include a fingerprint sensing area substantially arranged on the fingerprint sensor 220. The one or more processors may be individually or collectively operable to execute the instructions to cause the electronic device to perform an operation of displaying the second screen, such that the fingerprint sensing area is displayed to have a brightness higher than that of a corresponding area of the first screen.

In an embodiment, the one or more processors may be individually or collectively operable to execute the instructions to cause the electronic device to display a first guide image and a second guide image, which differ for at least one attribute, in the corresponding area and the fingerprint sensing area, respectively.

In an embodiment, the one or more processors may be individually or collectively operable to execute the instructions to cause the electronic device to, based at least partially on receiving a fingerprint input request, display the first screen via the display 210.

In an embodiment, the one or more processors may be individually or collectively operable to execute the instructions to cause the electronic device to monitor a user's finger contact on the display 210 while displaying the first screen. The one or more processors may be individually or collectively operable to execute the instructions to cause the electronic device to obtain the first image, based further on the contact being detected.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device comprising:
a display;
a fingerprint sensor under the display;
one or more memories configured to store processor-executable instructions; and
one or more processors comprising electronic circuitry,
wherein the one or more processors are individually or collectively operable to execute the instructions stored on the one or more memories to cause the electronic device to:
detect an occurrence of an event for sensing a fingerprint of a user,
based on detecting the occurrence, obtain a first image using the fingerprint sensor before the display emits light at a predetermined intensity for sensing the fingerprint,
analyze at least one pattern corresponding to a flicker noise included in the first image to obtain an analysis result,
based on the analysis result, adjust at least one exposure time of the fingerprint sensor for sensing the light reflected by the fingerprint of the user, and
based on the adjusted at least one exposure time, obtain a second image using the fingerprint sensor by sensing the light reflected by the fingerprint of the user.

2. The electronic device of claim 1, wherein the one or more processors are individually or collectively operable to execute the instructions to further cause the electronic device to:
based on detecting the occurrence of the event, and before the display emits the light:
provide, to the display, a first signal for emitting the light, and provide, to the fingerprint sensor, a second signal for obtaining the first image, and
obtain the first image based on a plurality of pixel values that are obtained sequentially in units of rows of pixels included in the fingerprint sensor.

3. The electronic device of claim 2, wherein the first signal comprises:
a command for activating the fingerprint sensor,
a command for obtaining, by the fingerprint sensor, first pixel values corresponding to the first image,
a command for obtaining, by the fingerprint sensor, second pixel values corresponding to the second image after emitting the light, and
the at least one exposure time stored in the one or more memories.

4. The electronic device of claim 1, wherein the at least one first pattern comprises a plurality of first portions and a plurality of second portions that are darker than the plurality of first portions, wherein the plurality of first portions and the plurality of second portions appear alternatingly and repeatedly in the first image, and
wherein the one or more processors are individually or collectively operable to execute the instructions to further cause the electronic device to:
obtain an average pixel value corresponding to each row from among the rows,
determine an interval at which the plurality of first portions and the plurality of second portions appear in the first image,
determine a number of the rows corresponding to the interval, and
wherein the at least one exposure time is adjusted based on the determined number to obtain the adjusted at least one exposure time.

5. The electronic device of claim 1, wherein the occurrence of the event is detected while displaying a screen for registering the fingerprint using the display, and
wherein the one or more processors are individually or collectively operable to execute the instructions to further cause the electronic device to:
based on the adjusted at least one exposure time, obtain one or more fingerprint images using the fingerprint sensor by sensing the light, reflected by the fingerprint of the user.

6. The electronic device of claim 1, wherein the first image is obtained based on displaying a fingerprint icon using the display.

7. The electronic device of claim 1, wherein the one or more processors are individually or collectively operable to execute the instructions to further cause the electronic device to:
determine a number of a plurality of activated pixels, which are in on state, from among a plurality of first pixels in a region corresponding to a location of the fingerprint sensor; and
obtain the first image based on determining that a ratio of the number of the plurality of activated pixels to the number of the plurality of first pixels is equal to or greater than a predetermined ratio.

8. A method of controlling a fingerprint sensor in an electronic device, the method comprising:
detecting an occurrence of an event for sensing a fingerprint of a user;
based on the detecting of the occurrence of the event, obtaining a first image using the fingerprint sensor before a display of the electronic device emits light at a predetermined intensity for sensing a fingerprint;
analyzing at least one pattern corresponding to a flicker noise included in the first image to obtain an analysis result;
based on the analysis result, adjusting at least one exposure time of the fingerprint sensor for sensing the light reflected by the fingerprint of the user; and
based on the adjusted at least one exposure time, obtaining a second image using the fingerprint sensor by sensing the light reflected by the fingerprint of the user.

9. The method of claim 8, wherein the obtaining of the first image using the fingerprint sensor comprises:
based on detecting the occurrence of the event, and before the display emits light at the predetermined intensity for sensing the fingerprint:
providing, to the display, a first signal for emitting the light, and providing, to the fingerprint sensor, a second signal for obtaining the first image; and
obtaining the first image based on a plurality of pixel values that are obtained sequentially in units of rows of pixels included in the fingerprint sensor.

10. The method of claim 9, wherein the first signal comprises:
a command for activating the fingerprint sensor,
a command for obtaining, by the fingerprint sensor, first pixel values of corresponding to the first image,
a command for obtaining, by the fingerprint sensor, second pixel values corresponding to the second image after emitting the light, and
the at least one exposure time stored in memory of the electronic device.

11. The method of claim 8, wherein the at least one pattern comprises a plurality of first portions and a plurality of second portions that are darker than the plurality of first portions, wherein the plurality of first portions and the plurality of second portions appears alternatingly and repeatedly in the first image,
wherein the analyzing of the at least one pattern comprises:
obtaining an average pixel value corresponding to each row from among the rows;
determining an interval at which the plurality of first portions and the plurality of second portions appear in the first image; and
determining a number of rows corresponding to the interval, and
wherein the at least one exposure time is adjusted based on the determined number to obtain the adjusted at least one exposure time.

12. The method of claim 8, wherein the occurrence of the event is detected while displaying a screen for registering the fingerprint using the display, and
wherein the method further comprises: based on the adjusted at least one exposure time, obtaining one or more fingerprint images using the fingerprint sensor by sensing the light reflected by the fingerprint of the user.

13. The method of claim 8, wherein the first image is obtained based on displaying a fingerprint icon using the display.

14. An electronic device comprising:
a display;
a fingerprint sensor under the display and configured to obtain an image by sensing light;
one or more memories storing processor-executable instructions; and
one or more processors comprising electronic circuitry,
wherein the one or more processors are individually or collectively operable to execute the instructions to cause the electronic device to:
display a first screen using the display;
during at least some of a time in which the first screen is displayed, obtain a first image using the fingerprint sensor according to a first exposure time;
based on the first image, determine a second exposure time for the fingerprint sensor;
detect a contact by a finger of a user;
based on the contact being detected, display a second screen using the display;
during at least some of a time in which the second screen is displayed, obtain a second image corresponding to the finger through the fingerprint sensor according to the second exposure time;
based on the second image, obtain fingerprint information corresponding to the finger; and
based on the fingerprint information, perform at least one of fingerprint authentication and fingerprint registration corresponding to the user.

15. The electronic device of claim 14, wherein the first exposure time is set based on refresh rate information associated with the display, and
wherein the one or more processors are individually or collectively operable to execute the instructions to further cause the electronic device to:
determine adjusted refresh rate information associated with the display based on the first image; and
determine the second exposure time based on the adjusted refresh rate information.

16. The electronic device of claim 14, further comprising sensor configured to detect external environment information corresponding to the electronic device,
wherein the one or more processors are individually or collectively operable to execute the instructions to cause the electronic device to:
detect the external environment information using the sensor; and
based on determining that the external environment information satisfies a predetermined condition, perform an operation for obtaining the first image.

17. The electronic device of claim 16, wherein the one or more processors are individually or collectively operable to execute the instructions to further cause the electronic device to:
based on the determining that the external environment information satisfies the predetermined condition, display, using the display, an indicator indicating that the operation for obtaining the first image is to be performed.

18. The electronic device of claim 16, wherein the one or more processors are individually or collectively operable to execute the instructions to further cause the electronic device to:
based on the determining that the external environment information satisfies the predetermined condition, display, using the display, a user interface for receiving a user input for executing the operation for obtaining the first image.

19. The electronic device of claim 14, wherein the second screen comprises a fingerprint sensing area on the fingerprint sensor, and
wherein the one or more processors are individually or collectively operable to execute the instructions to further cause the electronic device to display the second screen such that a brightness of the fingerprint sensing area is higher than a brightness of a corresponding area of the first screen.

20. The electronic device of claim 19, wherein the one or more processors are individually or collectively operable to execute the instructions to further cause the electronic device to display a first guide image in the corresponding area and a second guide image in the fingerprint sensing area, and
wherein the first guide image differs from the second guide image by at least one attribute.
